(19) United States
(12) Patent Application Publication
(10) Pub. No.: US 2009/0201229 A1
(43) Pub. Date: Aug. 13, 2009

(54) LIGHT-EMITTING APPARATUS, METHOD FOR PRODUCING LIGHT-EMITTING APPARATUS, AND ELECTRONIC APPARATUS

(75) Inventor: Hidekazu KOBAYASHI, Azumino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/028,398

(22) Filed: Feb. 8, 2008

(30) Foreign Application Priority Data
Mar. 8, 2007 (JP) 2007-058193

(51) Int. Cl. G09G 3/30

(52) U.S. Cl. 345/76

(57) ABSTRACT

The invention provides a light-emitting apparatus that has a plurality of pixels each of which has a set of four sub pixels including a red, a green, a blue, and a remaining sub pixel, together making up a display screen. Each of the sub pixels has a light-emitting layer and color filter that transmits light corresponding to the sub pixel. The light-emitting layer includes a white light-emitting material that emits three-peak white light, with an emission spectrum having a red peak, a green peak, and a blue peak falling within the wavelength range of red light, of green light, and of blue light, respectively. Low intensity regions exist between the red peak and the green peak and between the green peak and the blue peak. The light-emitting layers of the sub pixels extend along the display screen. The color filters overlap the light-emitting layers in a plan view.

### BACKGROUND

1. Technical Field

The present invention relates to a light-emitting apparatus and a method for producing the light-emitting apparatus. In addition, the invention further relates to an electronic apparatus that is provided with the light-emitting apparatus.

2. Related Art

In the technical field pertaining to the invention, various kinds of light-emitting apparatuses (i.e., full-color display apparatuses) have been developed so far. A light-emitting apparatus of the related art has a plurality of pixels that makes up a display screen. Each of the plurality of pixels has a set of sub pixels. Each of the sub pixels has an electroluminescent (EL) element such as an organic EL element or an inorganic EL element. Having such a configuration, a related-art light-emitting apparatus displays a color image on its display screen. Two typical examples of the related-art light-emitting apparatus are an RGB light-emitting apparatus and an RGBW light-emitting apparatus. Each pixel of the RGB light-emitting apparatus is made up of a red (R) sub pixel, a green (G) sub pixel, and a blue (B) sub pixel, whereas each pixel of the RGBW light-emitting apparatus is made up of a red (R) sub pixel, a green (G) sub pixel, a blue (B) sub pixel, and a white (W) sub pixel.

As a first type of the configuration of the RGB light-emitting apparatus (hereafter referred to as “a first related-art apparatus”), the light-emitting layer of each of the sub pixels is made of an EL material that emits light having corresponding one individual color that is assigned to the sub pixel. As a second type of the configuration of the RGB light-emitting apparatus (hereafter referred to as “a second related-art apparatus”), the light-emitting layer of each of the sub pixels is made of an EL material that emits white light, where the sub pixel has a color filter having filtering characteristics corresponding to an individual color assigned thereto. A reference for such a type of the related-art RGB light-emitting apparatus is found in, for example, JP-A-2001-57290. As a third type of the configuration of the RGB light-emitting apparatus (hereafter referred to as “a third related-art apparatus”), the light-emitting layer of each of the sub pixels is made of an EL material that emits blue light, where each of the red sub pixel and the green sub pixel of each pixel has a color conversion layer having color-conversion characteristics corresponding to the color assigned thereto.

On the other hand, in a typical configuration of the RGBW light-emitting apparatus, the light-emitting layer of each of the sub pixels is made of an EL material that emits white light, where each of the red sub pixel, the green sub pixel, and the blue sub pixel of each pixel has a color filter having filtering characteristics corresponding to an individual color assigned thereto. In the following description, the RGBW light-emitting apparatus having the typical configuration described above is referred to as “a fourth related-art apparatus”. It should be noted that the fourth related-art apparatus has white sub pixels in addition to the configuration of the second related-art apparatus.

The first related-art apparatus has a disadvantage in that it is practically impossible or at best difficult to achieve a high utilization efficiency of emitted light because it requires a polarization sheet (i.e., polarization film, or polarizing plate) in order to ensure protection against external light reflection. The second related-art apparatus has the same disadvantage in that it is practically impossible or at best difficult to achieve a high utilization efficiency of emitted light because there is considerably large optical loss caused by the color filter. The third related-art apparatus also has the same disadvantage in that it is practically impossible or at best difficult to achieve a high utilization efficiency of emitted light because it requires a color filter for the purpose of shutting unwanted light off. That is, in the configuration of the third related-art apparatus, the utilization efficiency of emitted light is low because there is considerably large optical loss caused by the color filter in addition to the optical loss caused by the color conversion layer. As explained above, the first, second, and third related-art apparatuses have a common disadvantage in that it is practically impossible or at best difficult to achieve a high utilization efficiency of emitted light. Therefore, in order to obtain a satisfactory display quality with the configuration of the first, second, and third related-art apparatuses described above, there is no other choice but to increase power consumption thereof.

In contrast, the fourth related-art apparatus features a sufficiently high utilization efficiency of emitted light because it is possible to represent white in a pixel as a whole just by emitting light without any color processing at the white sub pixel thereof. However, when a pixel represents red, green, or blue, the utilization efficiency of emitted light offered by the fourth related-art apparatus is relatively low (e.g., 30%, or 10%) as in the case of the second related-art apparatus. To sum up, although the fourth related-art apparatus features a sufficiently high utilization efficiency of light emitted in the white sub pixel of each pixel thereof, it is practically impossible or at best difficult to achieve a high utilization efficiency of light emitted in the remaining red, green, and blue sub pixels of each pixel thereof. Therefore, in order to obtain a satisfactory display quality with the configuration of the fourth related-art apparatus described above, there is no other choice but to increase power consumption thereof, which is the same problem as that of the first, second, and third related-art apparatuses described above.

As a modification of the fourth related-art apparatus described above, it is possible to conceive “a fifth related-art apparatus”. The fifth related-art apparatus is another example of the RGBW light-emitting apparatus. In the configuration of the fifth apparatus, the light-emitting layer of each of the sub pixels is made of an EL material that emits light having corresponding one individual color assigned to the sub pixel. The fifth related-art apparatus features a sufficiently high utilization efficiency of light emitted in each sub pixel. However, the fifth related-art apparatus has a disadvantage in that it is necessary to color four types of EL materials different from one another in the manufacturing process thereof. That is, the fifth related-art apparatus has a disadvantage in that its manufacturing process is too burdensome to be implemented in a practical sense.

In order to provide a solution to the relatively complex manufacturing problem described above, a sixth related-art apparatus is considered here. The sixth related-art apparatus is another example of the RGB light-emitting apparatus that is theoretically obtained by removing white sub pixels from the configuration of the fifth related-art apparatus. The sixth related-art apparatus also features a sufficiently high utilization efficiency of light emitted in each sub pixel. In addition, since it is only three types of EL materials that need to be colored different from one another in the manufacturing process of the sixth related-art apparatus, the production thereof is simplified in comparison with that of the fifth related-art apparatus. However, it is hard to say that the manufacturing process of the sixth related-art apparatus is simple enough to be actually implemented. Moreover, in order to represent white with the sub pixel configuration of each pixel of the sixth related-art apparatus, it is necessary to use all of three sub pixels thereof, which makes it practically impossible or at best difficult to achieve a high utilization efficiency of emitted light.

### SUMMARY

An advantage of some aspects of the invention is to provide a light-emitting apparatus that is capable of displaying an image with high quality with low power consumption, where the above-mentioned light-emitting apparatus can be manufactured with a sufficiently simple production process. In addition, the invention further provides, advantageously, a method for producing the above-mentioned light-emitting apparatus, and an electronic apparatus that is provided with the above-mentioned light-emitting apparatus.

In order to address the above-identified problem without any limitation thereto, the invention provides, as a first aspect thereof, a light-emitting apparatus that has a plurality of pixels each of which has a set of four sub pixels and, as a whole, which make up a display screen, the light-emitting apparatus, in each one of the pixels thereof, comprising: a red sub pixel that is one of the above-mentioned four sub pixels, the red sub pixel having a light-emitting layer and a red color filter, the light-emitting layer of the red sub pixel being made of a white light-emitting material that emits three-peak white light, the emission spectrum of the three-peak white light that is emitted by the white light-emitting material having a red peak, a green peak, and a blue peak, the red peak falling within the wavelength range of red light, the green peak falling within the wavelength range of green light, and the blue peak falling within the wavelength range of blue light, low intensity regions existing between the red peak and the green peak as well as between the green peak and the blue peak, the light-emitting layer of the red sub pixel extending along the display screen, the red color filter overlapping the light-emitting layer of the red sub pixel in a plan view, the red color filter transmitting red light; a green sub pixel that is one of the above-mentioned four sub pixels, the green sub pixel having a light-emitting layer and a green color filter, the light-emitting layer of the green sub pixel being made of the white light-emitting material, the light-emitting layer of the green sub pixel extending along the display screen, the green color filter overlapping the light-emitting layer of the green sub pixel in a plan view, the green color filter transmitting green light; a blue sub pixel that is one of the above-mentioned four sub pixels, the blue sub pixel having a light-emitting layer and a blue color filter, the light-emitting layer of the blue sub pixel being made of the white light-emitting material, the light-emitting layer of the blue sub pixel extending along the display screen, the blue color filter overlapping the light-emitting layer of the blue sub pixel in a plan view, the blue color filter transmitting blue light; and a remaining sub pixel that is one of the above-mentioned four sub pixels, the remaining sub pixel having a light-emitting layer, the light-emitting layer of the remaining sub pixel being made of the white light-emitting material, the light-emitting layer of the remaining sub pixel extending along the display screen. Each of the sub pixels includes one light-emitting element (e.g., an EL element such as an organic EL element, though not limited thereto).

In the configuration of the light-emitting apparatus according to the first aspect of the invention described above, a color represented by the remaining sub pixel in each of the pixels thereof can be arbitrarily determined. With such a configuration of the light-emitting apparatus according to the first aspect of the invention described above, it is possible to improve the utilization efficiency of light emitted in each sub pixel to a sufficiently high level, which makes it further possible to display an image in high quality with low power consumption. In addition, in the configuration of the light-emitting apparatus according to the first aspect of the invention described above, in each pixel, the light-emitting layer of each sub pixel is made of the same material as that of other sub pixels; that is, the same single material can be used for production of these light-emitting layers. Therefore, it is possible to manufacture the light-emitting layers of the light-emitting apparatus according to the first aspect of the invention described above by using only one type of material. For this reason, the manufacturing process of the light-emitting apparatus is substantially simplified. Therefore, the light-emitting apparatus according to the first aspect of the invention described above is capable of displaying an image with high quality with low power consumption; and in addition thereto, the light-emitting apparatus according to the first aspect of the invention described above can be manufactured with a sufficiently simple production process.

In the configuration of the light-emitting apparatus according to the first aspect of the invention described above, in each one of the pixels thereof, it is preferable that the remaining sub pixel should be a pink sub pixel that has a pink color filter overlapping the light-emitting layer in a plan view, where the pink color filter transmits pink light (hereafter referred to as “a first sub-aspect”). It is possible to represent pink by means of light having the wavelength range of red light and light having the wavelength range of blue light. Therefore, the first sub-aspect of the invention makes it possible to improve the utilization efficiency of light emitted in the pink sub pixel to a sufficiently high level, which is achieved by adopting a color filter that transmits the light having the wavelength range of red light and the light having the wavelength range of blue light as a color filter that transmits pink light. Therefore, with the preferred configuration of the light-emitting apparatus according to the first sub-aspect of the invention described above, it is also possible to improve the utilization efficiency of emitted light when white is represented by a combination of the pink sub pixel and the green sub pixel. In order to make certain one pixel represent white, the aforementioned sixth apparatus requires the emission of light from three sub pixels, that is, a red sub pixel, a green sub pixel, and a blue sub pixel thereof. In contrast, with the preferred configuration of the light-emitting apparatus according to the first sub-aspect of the invention described above, it is possible to represent white by emitting light from two sub pixels only, that is, a pink sub pixel and a green sub pixel thereof. That is, the light-emitting apparatus according to the first sub-aspect of the invention described above has an advantage over the aforementioned sixth apparatus in that it offers a higher utilization efficiency of emitted light when white is represented.

It is preferable that the light-emitting apparatus according to the first sub-aspect of the invention described above should further include: a flat element substrate, wherein, in each of the pixels, the light-emitting layer of each of the above-mentioned four sub pixels is formed over the element substrate in such a manner that the light-emitting layer of each of the above-mentioned four sub pixels is interposed between the corresponding color filter and the element substrate; each of the above-mentioned four sub pixels has a light-transmissive layer, which has optical transparency, between the corresponding light-emitting layer and the element substrate; each of the above-mentioned four sub pixels has a light-reflective layer, which has optical reflectivity, between the corresponding light-transmissive layer and the element substrate; and the thickness of the light-transmissive layer of each of the red sub pixel, the blue sub pixel, and the pink sub pixel is set at a value equal to one another so that light having a wavelength of the red peak and light having a wavelength of the blue peak are intensified concurrently with each other due to optical interference, whereas the thickness of the light-transmissive layer of the green sub pixel is set at a value so that light having a wavelength of the green peak is intensified due to optical interference.

The light-emitting apparatus having the preferred configuration described above is a top-emission type apparatus. The light-emitting apparatus having the preferred configuration described above has a light-reflective layer between the light-emitting layer of the pink sub pixel and the element substrate. In addition, in the preferred configuration of the light-emitting apparatus described above, the thickness of the light-transmissive layer between the light-emitting layer and the element substrate is set in consideration of optical interference in each of the red sub pixel, the green sub pixel, the blue sub pixel, and the pink sub pixel in each of the pixels thereof. Therefore, the light-emitting apparatus having the preferred configuration described above makes it possible to increase the brightness level of each of the red sub pixel, the green sub pixel, the blue sub pixel, and the pink sub pixel in each of the pixels thereof. Generally speaking, the emission spectrum of the light-emitting layer in a pink sub pixel has a wide wavelength range. Therefore, if any specific light that has a certain wavelength only is intensified due to optical interference among all components of light emitted by the light-emitting layer of the pink sub pixel, it is possible that the hue of P light gets changed so that the pink sub pixel represents a color other than pink, which is undesirable. In contrast, in the preferred configuration of the light-emitting apparatus described above, light component of a red peak wavelength and light component of a blue peak wavelength are intensified among all components of light emitted by the light-emitting layer thereof because the thickness of the light-transmissive layer of each of the red sub pixel, the blue sub pixel, and the pink sub pixel is set at a value equal to one another so that light having a wavelength of the red peak and light having a wavelength of the blue peak are intensified concurrently with each other due to optical interference. Red light and blue light constitute two components among three components of three-peak white light. In addition, these red light and blue light transmit through the color filter of the pink sub pixel to make up pink light. On the basis of these facts, the light-emitting apparatus having the preferred configuration described above makes it possible to increase the brightness level of each of the red sub pixel, the green sub pixel, the blue sub pixel, and the pink sub pixel in each of the pixels thereof while avoiding the purity of the color represented by the pink sub pixel from being degraded.

In the configuration of the light-emitting apparatus according to the first aspect of the invention described above, in each one of the pixels thereof, it is preferable that the remaining sub pixel should be a white sub pixel that represents white (hereafter referred to as “a second sub-aspect”). Light emitted by the light-emitting layer of the white sub pixel is white light. Therefore, in the preferred configuration of the light-emitting apparatus according to the second sub-aspect of the invention described above, it is possible to represent white in a pixel as a whole just by emitting light without any color processing at the white sub pixel thereof. That is, the light-emitting apparatus according to the second sub-aspect of the invention described above makes it possible to improve the utilization efficiency of light emitted in the white sub pixel in each of the pixels thereof.

It is preferable that the light-emitting apparatus according to the second sub-aspect of the invention should further include: a flat element substrate, wherein, in each of the pixels, the light-emitting layer of each of the above-mentioned four sub pixels is formed over the element substrate in such a manner that the light-emitting layer of each of the above-mentioned four sub pixels is interposed between the corresponding color filter and the element substrate; each of the above-mentioned four sub pixels has a light-transmissive layer, which has optical transparency, between the corresponding light-emitting layer and the element substrate; each of the above-mentioned four sub pixels has a light-reflective layer, which has optical reflectivity, between the corresponding light-transmissive layer and the element substrate; the thickness of the light-transmissive layer of the red sub pixel is set at a value so that light having a wavelength of the red peak is intensified due to optical interference; the thickness of the light-transmissive layer of the green sub pixel is set at a value so that light having a wavelength of the green peak is intensified due to optical interference; the thickness of the light-transmissive layer of the blue sub pixel is set at a value so that light having a wavelength of the blue peak is intensified due to optical interference; and the light-transmissive layer of the remaining sub pixel has three portions that have thicknesses different from one another, the thickness of a first portion of the light-transmissive layer of the remaining sub pixel being set at a value so that light having a wavelength of the red peak is intensified due to optical interference, the thickness of a second portion of the light-transmissive layer of the remaining sub pixel being set at a value so that light having a wavelength of the green peak is intensified due to optical interference, and the thickness of a third portion of the light-transmissive layer of the remaining sub pixel being set at a value so that light having a wavelength of the blue peak is intensified due to optical interference.

The light-emitting apparatus having the preferred configuration described above is a top-emission type apparatus. The light-emitting apparatus having the preferred configuration described above has a light-reflective layer between the light-emitting layer of the white sub pixel and the element substrate. In addition, in the preferred configuration of the light-emitting apparatus described above, the thickness of the light-transmissive layer between the light-emitting layer and the element substrate is set in consideration of optical interference. Therefore, the light-emitting apparatus having the preferred configuration described above makes it possible to increase the brightness level of each of the red sub pixel, the green sub pixel, the blue sub pixel, and the white sub pixel in each of the pixels thereof. Generally speaking, the emission spectrum of the light-emitting layer in a white sub pixel has a wide wavelength range. Therefore, if any specific light that has a certain wavelength only is intensified due to optical interference among all components of light emitted by the light-emitting layer of the white sub pixel, it is possible that the hue of W light gets changed so that the white sub pixel represents a color other than white, which is undesirable. In contrast, in the preferred configuration of the light-emitting apparatus described above, light component of a red peak wavelength, light component of a green peak wavelength, and light component of a blue peak wavelength are intensified among all components of light emitted by the light-emitting layer thereof because the light-transmissive layer of the white sub pixel has three portions that have thicknesses different from one another, where the thickness of a first portion of the light-transmissive layer of the white sub pixel is set at a value so that light having a wavelength of a red peak is intensified due to optical interference, the thickness of a second portion of the light-transmissive layer of the white sub pixel is set at a value so that light having a wavelength of a green peak is intensified due to optical interference, and the thickness of a third portion of the light-transmissive layer of the white sub pixel is set at a value so that light having a wavelength of a blue peak is intensified due to optical interference. Red light, green light, and blue light constitute three components of three-peak white light. In addition, these red light, green light, and blue light transmit through the color filter of the white sub pixel to make up white light. On the basis of these facts, the light-emitting apparatus having the preferred configuration described above makes it possible to increase the brightness level of each of the red sub pixel, the green sub pixel, the blue sub pixel, and the white sub pixel in each of the pixels thereof while avoiding the purity of the color represented by the white sub pixel from being degraded.

It is preferable that the light-emitting apparatus according to the first aspect of the invention, the first sub-aspect of the invention, or the second sub-aspect of the invention should further include: a flat element substrate; and a light absorption layer that is formed under the element substrate, wherein, in each of the pixels, the light-emitting layer of each of the above-mentioned four sub pixels is formed over the element substrate in such a manner that the light-emitting layer of each of the red sub pixel, the green sub pixel, and the blue sub pixel is interposed between the corresponding color filter and the element substrate. The light-emitting apparatus having the preferred configuration described above is a top-emission type apparatus; and therefore, light emitted by the light-emitting layer goes out from a side opposite the element substrate thereof. The light-emitting apparatus having the preferred configuration described above has an advantage in that, even if the element substrate thereof is made of a light-transmissive material, contrast is not sacrificed because the light absorption layer thereof absorbs any unwanted light.

It is preferable that the light-emitting apparatus according to the first aspect of the invention, the first sub-aspect of the invention, or the second sub-aspect of the invention should further include: a flat element substrate, wherein, in each of the pixels, the light-emitting layer of each of the above-mentioned four sub pixels is formed over the element substrate in such a manner that the color filter of each of the red sub pixel, the green sub pixel, and the blue sub pixel is interposed between the corresponding light-emitting layer and the element substrate; and each of the red sub pixel, the green sub pixel, and the blue sub pixel has a transflective layer having optical transparency and optical reflectivity between the corresponding light-emitting layer and the corresponding color filter. The light-emitting apparatus having the preferred configuration described above is a bottom-emission type apparatus; and therefore, light emitted by the light-emitting layer goes out through the element substrate thereof. Therefore, the light-emitting apparatus having the preferred configuration described above is capable of displaying an image with high quality with low power consumption; and in addition thereto, the light-emitting apparatus having the preferred configuration described above can be manufactured with a sufficiently simple production process. In the preferred configuration of the light-emitting apparatus described above, in each of the red sub pixel, the green sub pixel, and the blue sub pixel of each of the pixels, the transflective layer may function as an electrode thereof.

In the configuration of the light-emitting apparatus according to the first aspect of the invention, the first sub-aspect of the invention, or the second sub-aspect of the invention, including the preferred configuration thereof described above, it is preferable that, in each of the pixels, the light-emitting layer of the red sub pixel, the light-emitting layer of the green sub pixel, the light-emitting layer of the blue sub pixel, and the light-emitting layer of the remaining sub pixel constitute the same single light-emitting layer. The light-emitting apparatus having the preferred configuration described above makes it possible to easily form the common light-emitting layer of all sub pixels in each of the pixels in the same single film formation process in its manufacturing processes. Any organic layer other than the light-emitting layer may also be configured as the same single layer that is common to all of the red sub pixel, the green sub pixel, the blue sub pixel, and the remaining sub pixel in each of the pixels. The light-transmissive layer may also be configured as the same single layer that is common to all of the red sub pixel, the green sub pixel, the blue sub pixel, and the remaining sub pixel in each of the pixels.

In order to address the above-identified problem without any limitation thereto, the invention provides, as a second aspect thereof, an electronic apparatus that is provided with the light-emitting apparatus according to the first aspect of the invention, the first sub-aspect of the invention, or the second sub-aspect of the invention, including the preferred configuration thereof described above. The electronic apparatus according to the second aspect of the invention described above offers the same advantageous effects as those produced by the light-emitting apparatus according to the first aspect of the invention, the first sub-aspect of the invention, or the second sub-aspect of the invention, including the preferred configuration thereof described above.

In order to address the above-identified problem without any limitation thereto, the invention provides, as a third aspect thereof, a method for producing a light-emitting apparatus that has a plurality of pixels each of which has a set of four sub pixels and, as a whole, which make up a display screen, the light-emitting apparatus, in each one of the pixels thereof, having a red sub pixel that is one of the above-mentioned four sub pixels, the red sub pixel having a light-emitting layer and a red color filter, the light-emitting layer of the red sub pixel being made of a white light-emitting material that emits three-peak white light, the emission spectrum of the three-peak white light that is emitted by the white light-emitting material having a red peak, a green peak, and a blue peak, the red peak falling within the wavelength range of red light, the green peak falling within the wavelength range of green light, and the blue peak falling within the wavelength range of blue light, low intensity regions existing between the red peak and the green peak as well as between the green peak and the blue peak, the light-emitting layer of the red sub pixel extending along the display screen, the red color filter overlapping the light-emitting layer of the red sub pixel in a plan view, the red color filter transmitting red light, a green sub pixel that is one of the above-mentioned four sub pixels, the green sub pixel having a light-emitting layer and a green color filter, the light-emitting layer of the green sub pixel being made of the white light-emitting material, the light-emitting layer of the green sub pixel extending along the display screen, the green color filter overlapping the light-emitting layer of the green sub pixel in a plan view, the green color filter transmitting green light, a blue sub pixel that is one of the above-mentioned four sub pixels, the blue sub pixel having a light-emitting layer and a blue color filter, the light-emitting layer of the blue sub pixel being made of the white light-emitting material, the light-emitting layer of the blue sub pixel extending along the display screen, the blue color filter overlapping the light-emitting layer of the blue sub pixel in a plan view, the blue color filter transmitting blue light, and a remaining sub pixel that is one of the above-mentioned four sub pixels, the remaining sub pixel having a light-emitting layer, the light-emitting layer of the remaining sub pixel being made of the white light-emitting material, the light-emitting layer of the remaining sub pixel extending along the display screen, the above-mentioned method for producing a light-emitting apparatus comprising: forming, in each of the pixels, the light-emitting layer of the red sub pixel, the light-emitting layer of the blue sub pixel, and the light-emitting layer of the remaining sub pixel on an element substrate that extends along the display screen by using the white light-emitting material in the same single formation process.

With the configuration of a light-emitting apparatus that is manufactured by the production method according to the third aspect of the invention described above, it is possible to display an image with high quality with low power consumption. In addition, in the production method according to the third aspect of the invention described above, it is possible to form the common light-emitting layer of all sub pixels in each of the pixels in the same single film formation process. Thus, with the production method according to the third aspect of the invention described above, it is possible to manufacture a light-emitting apparatus that is capable of displaying an image with high quality with low power consumption, which can be manufactured with a sufficiently simple production process.

### BRIEF DESCRIPTION OF THE DRAWINGS

The invention will be described with reference to the accompanying drawings, wherein like numbers reference like elements.

FIG. 1 is a plan view that schematically illustrates an example of the configuration of a light-emitting apparatus 10 according to a first exemplary embodiment of the invention.

FIG. 2 is a plan view that schematically illustrates an example of the configuration of a pixel P of the light-emitting apparatus 10,

FIG. 3 is a sectional view that schematically illustrates an example of the configuration of the pixel P shown in FIG. 2.

FIG. 4 is a graph that shows the utilization efficiency of light emitted in a red sub pixel 1R, a blue sub pixel 1B, and a pink sub pixel 1P in the light-emitting apparatus 10.

FIG. 5 is a graph that shows the utilization efficiency of light emitted in a green sub pixel 1G in the light-emitting apparatus 10.

FIG. 6 is a sectional view that schematically illustrates an example of a first step of the production process of the light-emitting apparatus 10.

FIG. 7 is a sectional view that schematically illustrates an example of a next step of the production process of the light-emitting apparatus 10 subsequent to the step illustrated in FIG. 6.

FIG. 8 is a sectional view that schematically illustrates an example of a next step of the production process of the light-emitting apparatus 10 subsequent to the step illustrated in FIG. 7.

FIG. 9 is a sectional view that schematically illustrates an example of the configuration of a pixel P2 of a light-emitting apparatus according to a second exemplary embodiment of the invention.

FIG. 10 is a sectional view that schematically illustrates an example of the configuration of a pixel P3 of a light-emitting apparatus according to a third exemplary embodiment of the invention.

FIG. 11 is a plan view that schematically illustrates an example of the configuration of the pixel P3.

FIG. 12 is a sectional view that schematically illustrates an example of a first step of the production process of the light-emitting apparatus according to the third exemplary embodiment of the invention.

FIG. 13 is a sectional view that schematically illustrates an example of a next step of the production process of the light-emitting apparatus according to the third exemplary embodiment of the invention subsequent to the step illustrated in FIG. 12.

FIG. 14 is a sectional view that schematically illustrates an example of a next step of the production process of the light-emitting apparatus according to the third exemplary embodiment of the invention subsequent to the step illustrated in FIG. 13.

FIG. 15 is a sectional view that schematically illustrates an example of a next step of the production process of the light-emitting apparatus according to the third exemplary embodiment of the invention subsequent to the step illustrated in FIG. 14.

FIG. 16 is a sectional view that schematically illustrates an example of the configuration of a pixel P4 of a light-emitting apparatus according to a fourth exemplary embodiment of the invention.

FIG. 17 is a sectional view that schematically illustrates an example of the configuration of a pixel P5 of a light-emitting apparatus according to a fifth exemplary embodiment of the invention.

FIG. 18 is a sectional view that schematically illustrates an example of the configuration of a pixel P6 of a light-emitting apparatus according to a sixth exemplary embodiment of the invention.

FIG. 19 is a diagram that schematically illustrates a variation example of exemplary embodiments of the invention.

FIGS. 20A and 20B is a set of diagrams that schematically illustrates a variation example of exemplary embodiments of the invention.

FIG. 21 is a diagram that schematically illustrates an example of the configuration of a mobile personal computer that adopts the light-emitting apparatus 10 as its display device.

FIG. 22 is a diagram that schematically illustrates an example of the configuration of a mobile phone that adopts the light-emitting apparatus 10 as its display device.

FIG. 23 is a diagram that schematically illustrates an example of the configuration of a personal digital assistant that adopts the light-emitting apparatus 10 as its display device.

### DESCRIPTION OF EXEMPLARY EMBODIMENTS

With reference to accompanying drawings, exemplary embodiments of a light-emitting apparatus, a method for producing the light-emitting apparatus, and an electronic apparatus that is provided with the light-emitting apparatus according to some aspects of the invention are explained below. It should be noted that, in the accompanying drawings that are mentioned below, the dimensions and/or scales of layers, members, and constituent elements are modified from those that will be adopted in an actual implementation of the invention for the purpose of making them easily recognizable in each illustration.

### First Embodiment

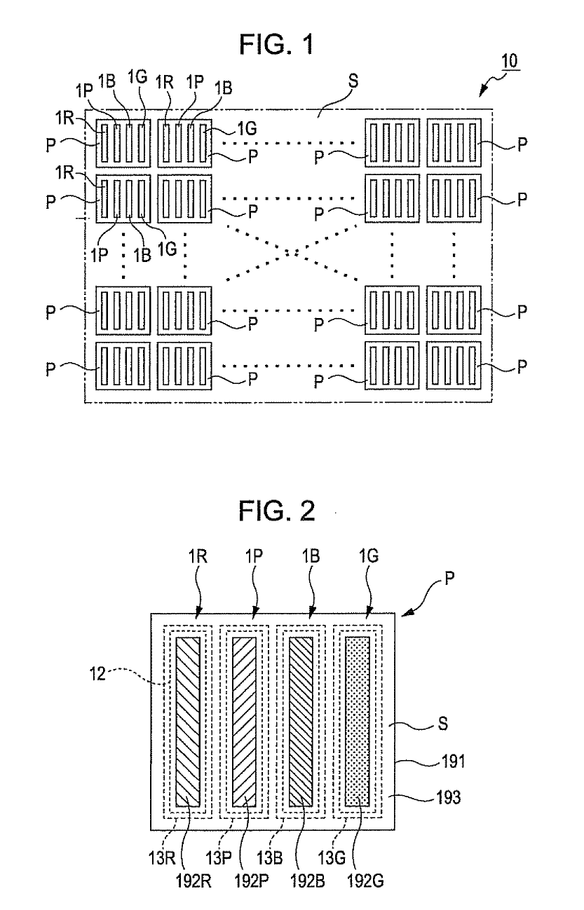

FIG. 1 is a plan view that schematically illustrates an example of the configuration of a light-emitting apparatus 10 according to a first exemplary embodiment of the invention. The light-emitting apparatus 10 is a full-color display apparatus that has a plurality of pixels P that makes up a rectangular display screen S. The plurality of pixels P is arrayed in a matrix pattern in the display screen S. Each one of the pixels P that constitute the display screen S has a set of four sub pixels 1. Each set of four sub pixels 1 is made up of a red sub pixel 1R that emits red light so as to represent a red color component, a green sub pixel 1G that emits green light so as to represent a green color component, a blue sub pixel 1B that emits blue light so as to represent a blue color component, and a pink sub pixel 1P that emits pink light so as to represent a pink color component. These sub pixels 1R, 1G, 1B, and 1P are arranged in a stripe-array pattern in the display screen S. In each of the plurality of pixels P, a color combination of the pink sub pixel 1P and the green sub pixel 1G represents white.

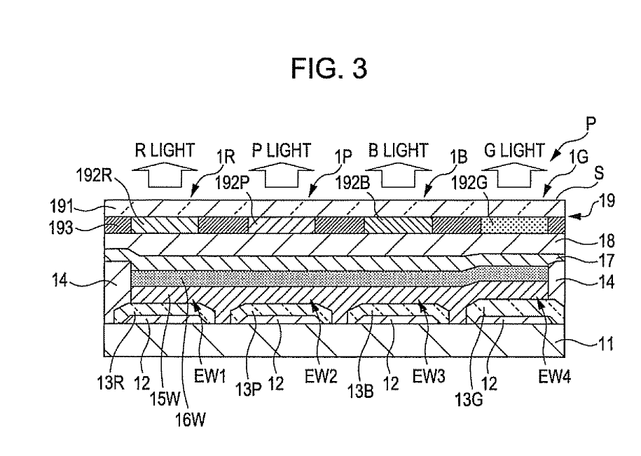

FIG. 2 is a plan view that schematically illustrates an example of the configuration of a pixel P of the light-emitting apparatus 10. FIG. 3 is a sectional view that schematically illustrates an example of the configuration of the pixel P shown in FIG. 2. In these drawings, needless to say, the same hatching patterns are applied to the same components. As illustrated in FIG. 3, the light-emitting apparatus 10 is provided with an element substrate 11. The element substrate 11 is configured as a flat-panel substrate on which a plurality of light-emitting elements EW is formed. These light-emitting elements EW are, though not necessarily limited thereto, organic EL elements. Each of the light-emitting elements EW is included in the corresponding one of the sub pixels 1; that is, there is “one-to-one” correspondence therebetween. Specifically, the red sub pixel 1R includes a white light-emitting element EW1. The pink sub pixel 1P includes a white light-emitting element EW2. The blue sub pixel 1B includes a white light-emitting element EW3. The green sub pixel 1G includes a white light-emitting element EW4.

Active elements such as thin film transistors (TFTs) can be formed on the element substrate 11. The element substrate 11 is made of, for example, glass, ceramic, or metal. A light-reflective layer 12 that totally reflects light is formed in each of the sub pixels 1. A material that constitutes the light-reflective layer 12 may be, for example, silver, aluminum, or any alloy that contains either one or both of silver and aluminum. A passivation layer, which is not shown in the drawing, overlies both of the element substrate 11 and the light-reflective layer 12. The passivation layer has a thickness of, for example, 200 nm. The passivation layer is made of, for example, silicon nitride. The light-emitting element EW is formed over the element substrate 11 and the light-reflective layer 12, or in other words, over the passivation layer, for each of the plurality of sub pixels 1. In the following description, a detailed explanation of the layer structure thereof is given.

A transparent electrode (i.e., light-transmissive layer) 13 is formed over the element substrate 11 and the light-reflective layer 12, or in other words, over the passivation layer, for each of the plurality of sub pixels 1. Each of the transparent electrodes 13 is made of a material that transmits light such as indium tin oxide (ITO) or the like. Each of the transparent electrodes 13 is formed in such a manner that it covers the light-reflective layer 12. Each of the pixels P has a set of four transparent electrodes 13. Each set of four transparent electrodes 13 is made up of a red transparent electrode 13R, a green transparent electrode 13G, a blue transparent electrode 13B, and a pink transparent electrode 13P. The thickness of the red transparent electrode 13R is the same as that of the blue transparent electrode 13B and the pink transparent electrode 13P. The thickness of the green transparent electrode 13G, which differs from that of the red transparent electrode 13R, the blue transparent electrode 13B, and the pink transparent electrode 13P, is, for example, 110 nm. The transparent electrode 13 functions as the positive electrode of the light-emitting element EW.

Partition walls 14 are formed above the element substrate 11 and the transparent electrodes 13, or in other words, above the passivation layer and the transparent electrodes 13. A combination of the partition walls 14 and the transparent electrodes 13 demarcates a common organic layer region for each of the light-emitting elements EW. The number of the organic layer region in each of the pixels P is one. A white hole injection layer (i.e., white electron-hole injection layer) 15W is formed in the organic layer region. A white light-emitting layer 16W is formed on the white hole injection layer 15W in the organic layer region. A white electron injection layer, which is not shown in the drawing, is formed on the white light-emitting layer 16W in the organic layer region.

In each of the pixels P, the white light-emitting layer 16W is formed as a layer that is common to all of the sub pixels 1 that make up the pixel P. In other words, the white light-emitting layer 16W includes a light-emitting layer region for each of the red sub pixel 1R, the pink sub pixel 1P, the blue sub pixel 1B, and the green sub pixel 1G (i.e., a red light-emitting layer, a pink light-emitting layer, a blue light-emitting layer, and a green light-emitting layer). The light-emitting layer for each of the sub pixels 1 extends along the display screen S (or, in other words, the element substrate 11). The thickness of the light-emitting layer for each of the sub pixels 1 is, for example, 30 nm. On the other hand, the thickness of the white hole injection layer 15W is, for example, 80 nm, whereas the thickness of the white electron injection layer is, for example, 20 nm. An organic functional layer that does not directly emit light such as a hole injection layer, a hole transportation layer, and the like may be formed as a layer that is common to all of the pixels.

As understood from the above explanation, each of the above-mentioned four sub pixels 1 of the pixel P has a light-transmissive layer (i.e., transparent electrode 13), which has optical transparency, between the light-emitting layer and the element substrate 11. In addition, each of the above-mentioned four sub pixels 1 of the pixel P has the light-reflective layer 12 between the light-transmissive layer and the element substrate 11. The white light-emitting layer 16W is made of an organic EL material that emits white light (hereafter referred to as a “white light-emitting material”). The white light-emitting material emits three-peak white light. The emission spectrum of the three-peak white light that is emitted by the white light-emitting material has a red peak, a green peak, and a blue peak. The red peak falls within the wavelength range of red light, specifically, within a range from 590 nm inclusive to 640 nm inclusive. The green peak falls within the wavelength range of green light, specifically, within a range from 500 nm inclusive to 570 nm inclusive. The blue peak falls within the wavelength range of blue light, specifically, within a range from 450 nm inclusive to 500 nm inclusive. In such an emission spectrum waveform, there are low spectral intensity regions between the red peak and the green peak as well as between the green peak and the blue peak.

A common electrode 17 is formed on the white electron injection layer. The common electrode 17 functions as a negative electrode that is common to all of the light-emitting elements EW. The common electrode 17 is formed as a transflective layer that transmits/reflects light. The thickness of the common electrode 17 is, for example, 10 nm. The common electrode 17 is made of, for example, an alloy containing magnesium and silver. As understood from the above explanation, the light-reflective layer 12 and the light-emitting element EW are formed for each of the sub pixels 1 over the element substrate 11.

The thickness of the transparent electrode 13 for each sub pixel 1 is set at a value that ensures that the optical distance between the light-reflective layer 12, which lies immediately under the transparent electrode 13, and the common electrode 17 intensifies, among all components of light emitted by the light-emitting layer, light that has a spectrum of corresponding one individual color that is assigned to the sub pixel 1 due to optical interference. The thickness of the red transparent electrode 13R is the same as that of the blue transparent electrode 13B and the pink transparent electrode 13P. Specifically, the thickness of each of these red, blue, and pink transparent electrodes 13R, 13B, and 13P is set at a value that ensures that the optical distance between the light-reflective layer 12 and the common electrode 17 intensifies, among all components of light emitted by the light-emitting layer, light that has a spectrum falling within the red wavelength range, specifically, within a range from 590 nm inclusive to 640 nm inclusive (preferably, 620 nm or in the neighborhood thereof) and light that has a spectrum falling within the blue wavelength range, specifically, within a range from 450 nm inclusive to 500 nm inclusive (preferably, 480 nm or in the neighborhood thereof) due to optical interference. On the other hand, the thickness of the green transparent electrode 13G is set at a value that ensures that the optical distance between the light-reflective layer 12 and the common electrode 17 intensifies, among all components of light emitted by the light-emitting layer, light that has a spectrum falling within the green wavelength range, specifically, within a range from 500 nm inclusive to 570 nm inclusive (preferably, 530 nm or in the neighborhood thereof) due to optical interference.

A sealing layer 18 is formed so as to cover all of the light-emitting elements EW over the element substrate 11 and the common electrode 17. The sealing layer 18 functions to seal the light-emitting elements EW for protection thereof. The sealing layer 18 is made of a material having optical transparency such as silicon nitride or silicon oxide. A color filter substrate 19 is provided on the sealing layer 18. The color filter substrate 19 has a transparent substrate 191 that is configured as a flat-panel substrate having optical transparency, a color filter 192 each color component thereof has one-to-one correspondence with the sub pixel 1, and a light-shielding black matrix 193.

The color filter 192 is a layer formed on the transparent substrate 191. Each of individual color filters (which are collectively denoted as “192”) transmits light having corresponding one individual color that is assigned to the corresponding sub pixel 1. For example, a red color filter 192R selectively transmits red light only. A blue color filter 192B selectively transmits blue light only. A pink color filter 192P selectively transmits pink light (red light and blue light) only. A green color filter 192G selectively transmits green light only. The black matrix 193 is a layer that is formed on the transparent substrate 191. The black matrix 193 is provided in each gap between the color filters 192R, 192P, 192B, and 192G.

The color-filter-side (192) surface of the color filter substrate 19 is in contact with the sealing layer 18. In each of the pixels P, the red color filter 192R overlaps the red light-emitting layer in a plan view. In like manner, the pink color filter 192P, the blue color filter 192B, and the green color filter 192G overlap the pink light-emitting layer, the blue light-emitting layer, and the green light-emitting layer in a plan view, respectively. That is, in each of the pixels P, the light-emitting layer of each of the sub pixels 1 is formed over the element substrate 11 in such a manner that it is interposed between the corresponding color filter 192 and the element substrate 11.

In other words, in each of the pixels P, the red sub pixel 1R has the red light-emitting layer and the red color filter 192R, which overlies the red light-emitting layer, whereas the pink sub pixel 1P has the pink light-emitting layer and the pink color filter 192P, which overlies the pink light-emitting layer. In like manner, in each of the pixels P, the blue sub pixel 1B has the blue light-emitting layer and the blue color filter 192B, which overlies the blue light-emitting layer, whereas the green sub pixel 1G has the green light-emitting layer and the green color filter 192G, which overlies the green light-emitting layer.

As understood from the above explanation, the light-emitting apparatus 10 according to the present embodiment of the invention is configured as a top-emission type organic EL apparatus. Therefore, light emitted by the light-emitting layer goes out from a side opposite the element substrate 11, that is, through the color filter substrate 19. Since each emitted light passes through the color filter 192 on its optical path, or in other words, since each outgoing light has passed through the color filter 192, light emitted by the red sub pixel 1R (i.e., R outgoing light) is colored red, whereas light emitted by the pink sub pixel 1P (i.e., P outgoing light) is colored pink. In like manner, light emitted by the blue sub pixel 1B (i.e., B outgoing light) is colored blue, whereas light emitted by the green sub pixel 1G (i.e., G outgoing light) is colored green.

As explained above, the light-emitting apparatus 10 has a plurality of the aforementioned pixels P, each of which has a set of the aforementioned four sub pixels 1. Each set of four sub pixels 1 thereof is made up of the aforementioned red sub pixel 1R, pink sub pixel 1P, blue sub pixel 1B, and green sub pixel 1G. In each of the pixels P, the red sub pixel 1R has the red light-emitting layer that is made of the aforementioned white light-emitting material, the emission spectrum of which has a red peak, a green peak, and a blue peak, and (the red sub pixel 1R) further has the red color filter 192R, which overlies the red light-emitting layer. In like manner, in each of the pixels P, the pink sub pixel 1P has the pink light-emitting layer that is made of the white light-emitting material and further has the pink color filter 192P, which overlies the pink light-emitting layer. The blue sub pixel 13 has the blue light-emitting layer that is made of the white light-emitting material and further has the blue color filter 192B, which overlies the blue light-emitting layer. In addition, the green sub pixel 10 has the green light-emitting layer that is made of the white light-emitting material and further has the green color filter 192G, which overlies the green light-emitting layer.

With the configuration of the light-emitting apparatus 10, it is possible to improve the utilization efficiency of light emitted in each sub pixel to a sufficiently high level. Therefore, it is possible to display an image in high quality with low power consumption. In addition, in the configuration of the light-emitting apparatus 10, in each pixel, the light-emitting layer of each sub pixel is made of the same material as that of other sub pixels; that is, the same single white light-emitting material can be used for production of these light-emitting layers. Therefore, it is possible to manufacture the light-emitting layers of the light-emitting apparatus 10 by using only one type of material. For this reason, the manufacturing process of the light-emitting apparatus 10 is simplified. Therefore, the light-emitting apparatus 10 is capable of displaying an image with high quality with low power consumption; and in addition thereto, the light-emitting apparatus 10 can be manufactured with a sufficiently simple production process.

As described above, the light-emitting apparatus 10 according to the present embodiment of the invention is configured as a top-emission type organic EL apparatus having the element substrate 11. In each of the pixels P, the light-emitting layer of each of the sub pixels 1 is formed over the element substrate 11 in such a manner that it is interposed between the corresponding color filter 192 and the element substrate 11. Each of the above-mentioned four sub pixels 1 of the pixel P has a light-transmissive layer (i.e., transparent electrode 13), which has optical transparency, between the light-emitting layer and the element substrate 11. In addition, each of the above-mentioned four sub pixels 1 of the pixel P has the light-reflective layer 12 between the light-transmissive layer and the element substrate 11. As has already been described above, in the configuration of the light-emitting apparatus 10 according to the present embodiment of the invention, the thickness of the transparent electrode 13 for each sub pixel 1 is set at a value that ensures that the optical distance between the light-reflective layer 12, which lies immediately under the transparent electrode 13, and the common electrode 17 intensifies, among all components of light emitted by the light-emitting layer, light that has a spectrum of corresponding one individual color that is assigned to the sub pixel 1 due to optical interference. Therefore, the light-emitting apparatus 10 according to the present embodiment of the invention makes it possible to increase the brightness level of each of the sub pixels 1.

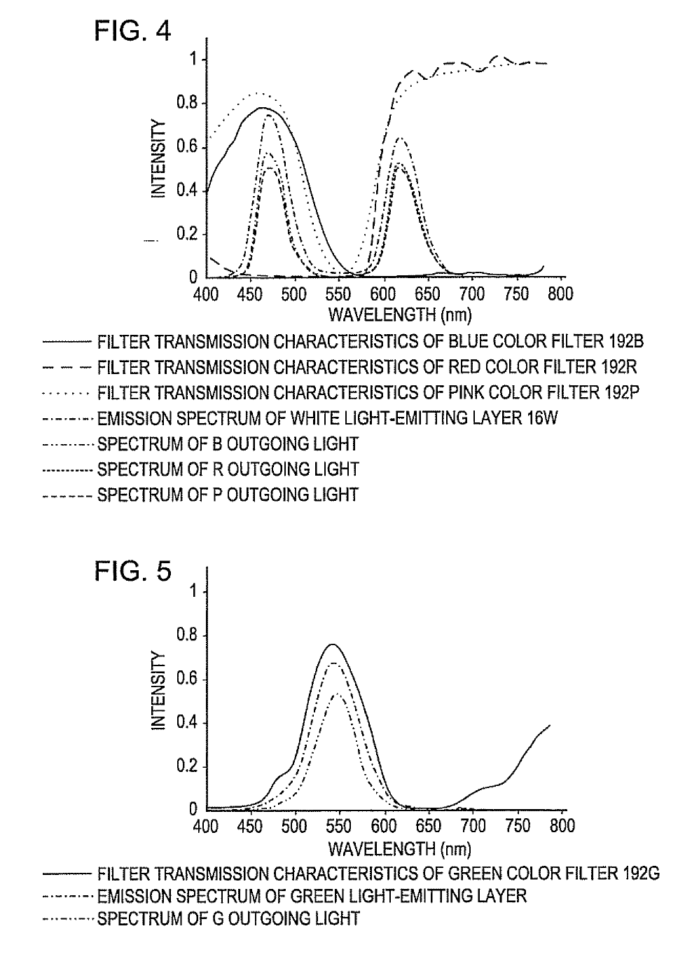

FIG. 4 is a graph that shows the utilization efficiency of light emitted in the red sub pixel 1R, the blue sub pixel 1B, and the pink sub pixel 1P in the light-emitting apparatus 10. This graph shows, for each of the red sub pixel 1R, the blue sub pixel 1B, and the pink sub pixel 1P, the emission spectrum of the light-emitting layer, the filter transmission characteristics of the color filter 192, and the spectrum of outgoing light (R light, B light, or P light). As understood from the graph of FIG. 4, the utilization efficiency of light emitted in each of the red sub pixel 1R and the blue sub pixel 1B is approximately 60-80%, which may be safely said as sufficiently high utilization efficiency thereof. Considering the fact that red and blue are colors that are relatively hard to be perceived with the naked eyes in comparison with green, the above-described sufficiently high utilization efficiency of light emitted in each of the red sub pixel 1R and the blue sub pixel 1B directly contributes to reduction in power consumption. In addition, as understood from the graph of FIG. 4, the utilization efficiency of light emitted in the pink sub pixel 1P is also sufficiently high. Moreover, this graph reveals that, with the configuration of the light-emitting apparatus 10 described above, light of green color component, which is relatively easy to be perceived with the naked eyes in comparison with, for example, red and blue, is shut off by the pink color filter 192P in the pink sub pixel 1P. By this reason, external light reflection is effectively reduced.

FIG. 5 is a graph that shows the utilization efficiency of light emitted in the green sub pixel 1G in the light-emitting apparatus 10. This graph shows the emission spectrum of the light-emitting layer of the green sub pixel 1G, the filter transmission characteristics of the green color filter 192G, and the spectrum of the green outgoing light (i.e., G light). As understood from the graph of FIG. 5, the utilization efficiency of light emitted in the green sub pixel 1G is approximately 50%, which may be safely said as sufficiently high utilization efficiency thereof.

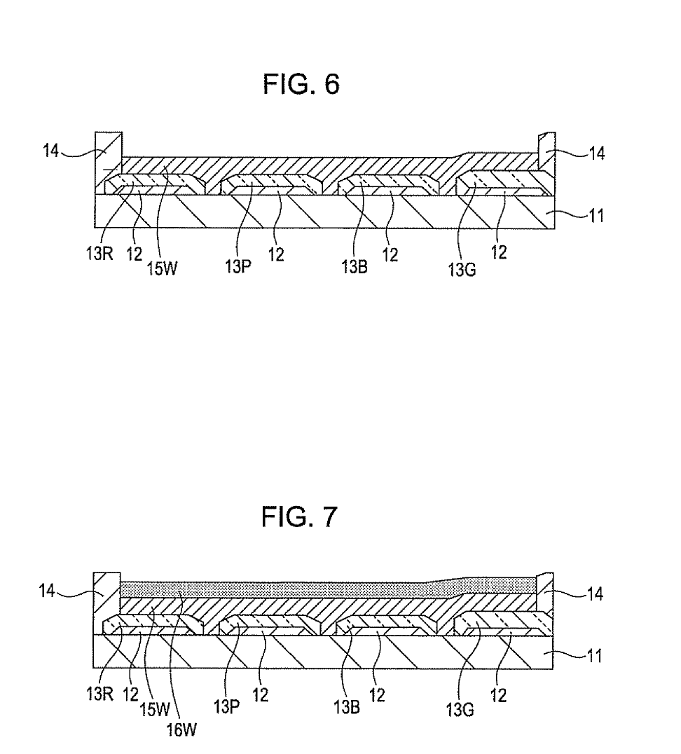

Next, a method for producing the light-emitting apparatus 10 is explained below. As a first step, as illustrated in FIG. 6, the light-reflective layer 12 is formed for each of the sub pixels 1 over the element substrate 11. Next, a passivation layer, which is not shown in the drawing, is formed to overlie both of the element substrate 11 and the light-reflective layer 12. Then, the transparent electrode 13 is formed over the element substrate 11 and the light-reflective layer 12, or in other words, over the passivation layer, for each of the plurality of sub pixels 1 in such a manner that it covers the light-reflective layer 12. Thereafter, the partition walls 14 are formed above the passivation layer and the transparent electrodes 13 so that a combination of the partition walls 14 and the transparent electrodes 13 demarcates a common organic layer region in each of the pixels P. The white hole injection layer 15W is formed in the organic layer region by means of a known film production method. As a method for producing an organic functional layer such as the white hole injection layer 15W and the like, for example, a physical vapor deposition method, a spin-on and other coating/application method, a sputtering method, a chemical vapor deposition (CVD) method, though not limited thereto, may be adopted. In a manufacturing process in which the transparent electrodes 13 are formed, it is necessary to control the thickness of each of the transparent electrodes 13 so that it meets the thickness requirements that are defined for each color type of the sub pixels 1 (i.e., the common thickness specified for the red sub pixel 1R, the pink sub pixel 1P, and the blue sub pixel 1B and the thickness specified for the green sub pixel 1G). Such a thickness control can be performed by, for example, depositing films one on another.

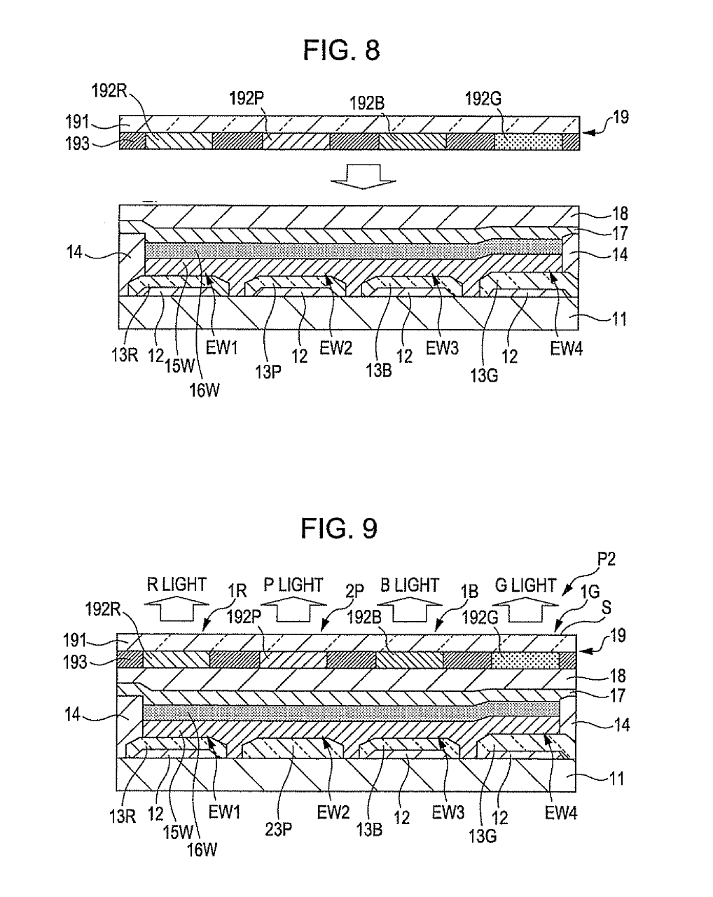

Next, as illustrated in FIG. 7, the white light-emitting layer 16W is formed on the white hole injection layer 15W in the organic layer region in each of the pixels P. The white light-emitting layer 16W is made of the white light-emitting material. As a result thereof, the light-emitting layer for each of the sub pixels 1 is formed in each of the pixels P. Next, the white electron injection layer, which is not shown in the drawing, is formed on the white light-emitting layer 16W in the organic layer region. Then, as illustrated in FIG. 8, the common electrode 17 is formed over the white electron injection layer (not shown therein) and the partition walls 14, which is followed by the formation of the sealing layer 18 over the common electrode 17 and the element substrate 11. Next, the color filter substrate 19 is adhered to the sealing layer 18. After the series of manufacturing processes described above, the production of the light-emitting apparatus 10 according to the present embodiment of the invention, which is illustrated in FIG. 3, is completed. As understood from the above description, the light-emitting apparatus 10 according to the present embodiment of the invention, and a method for production thereof, does not involve any complex and burdensome manufacturing process.

### Second Embodiment

FIG. 9 is a sectional view that schematically illustrates an example of the configuration of a pixel P2 of a light-emitting apparatus according to a second exemplary embodiment of the invention. The pixel P2 of the light-emitting apparatus according to the second exemplary embodiment of the invention corresponds to the pixel P of the light-emitting apparatus 10 according to the first exemplary embodiment of the invention. The configuration of the light-emitting apparatus according to the present embodiment of the invention (illustrated in FIG. 9) differs from that of the light-emitting apparatus 10 according to the first exemplary embodiment of the invention in the following three points. Firstly, the light-emitting apparatus according to the present embodiment of the invention is provided with a pink sub pixel 2P in place of the pink sub pixel 1P in each pixel thereof. Secondly, the light-emitting apparatus according to the present embodiment of the invention is provided with a light absorption layer 24 under the element substrate 11 thereof. Thirdly, the material of the element substrate 11 of the light-emitting apparatus according to the present embodiment of the invention is limited to one that has optical transparency (e.g., glass). The pink sub pixel 2P that is adopted in the light-emitting apparatus according to the present embodiment of the invention differs from the pink sub pixel 1P in the following two points. Firstly, the pink sub pixel 2P is not provided with the light-reflective layer 12. Secondly, the pink sub pixel 2P is provided with a pink transparent electrode 23P in place of the pink transparent electrode 13P. The pink transparent electrode 23P differs from the pink transparent electrode 13P only in that the pink transparent electrode 23P has a shape different from that of the pink transparent electrode 13P because the pink sub pixel 2P is not provided with the light-reflective layer 12. The pink transparent electrode 232 may be made of a light-shielding material.

In the configuration of the light-emitting apparatus according to the present embodiment of the invention, since the pink sub pixel 2P is not provided with the light-reflective layer 12, the utilization efficiency of light emitted in the pink sub pixel is relatively low in comparison with that of the first exemplary embodiment of the invention. However, it is unlikely that the hue of P light gets changed, which is undesirable, as a result of the intensification of any specific light that falls within certain one wavelength range due to optical interference among all components of light emitted by the light-emitting layer of the pink sub pixel 2P. Therefore, with the configuration of the light-emitting apparatus according to the present embodiment of the invention, it is possible to avoid the purity of the color represented by the pink sub pixel 2P from being degraded. In addition, although the element substrate 11 of the light-emitting apparatus according to the present embodiment of the invention is made of a light-transmissive material, the contrast of the pink sub pixel 2P is not sacrificed because the light absorption layer 24 thereof absorbs any unwanted light.

On the condition that a minor decrease in the utilization efficiency of light emitted in the pink sub pixel in comparison with that of the first exemplary embodiment of the invention can be tolerated to some degree, as in the case of the light-emitting apparatus according to the present embodiment of the invention, it is possible to further conceive the following modified configuration of the light-emitting apparatus 10 according to the first exemplary embodiment of the invention described above. For example, the thickness of the pink transparent electrode 13P of the light-emitting apparatus 10 according to the first exemplary embodiment of the invention described above may be modified within a range from 70 nm inclusive to 130 nm inclusive. In addition, in such a modification example, the thickness of the pink transparent electrode 13P may be set at a value that ensures that the optical distance between the light-reflective layer 12 and the common electrode 17 intensifies, among all components of light emitted by the light-emitting layer, light that has a spectrum falling within the blue wavelength range, specifically, within a range from 450 nm inclusive to 500 nm inclusive (preferably, 480 nm or in the neighborhood thereof), or light that has a spectrum falling within the red wavelength range, specifically, within a range from 590 nm inclusive to 640 nm inclusive (preferably, 620 nm or in the neighborhood thereof) due to optical interference. However, if so configured, there is an adverse possibility that the hue of P light gets undesirably changed as a result of the intensification of any specific light that has a certain wavelength (blue light or red light) due to optical interference among all components of light emitted by the light-emitting layer of the pink sub pixel. In order to provide a solution to such a problem, in the following description, a light-emitting apparatus according to another exemplary embodiment of the invention that has a configuration different from that of the light-emitting apparatus 10 according to the first exemplary embodiment of the invention is disclosed.

### Third Embodiment

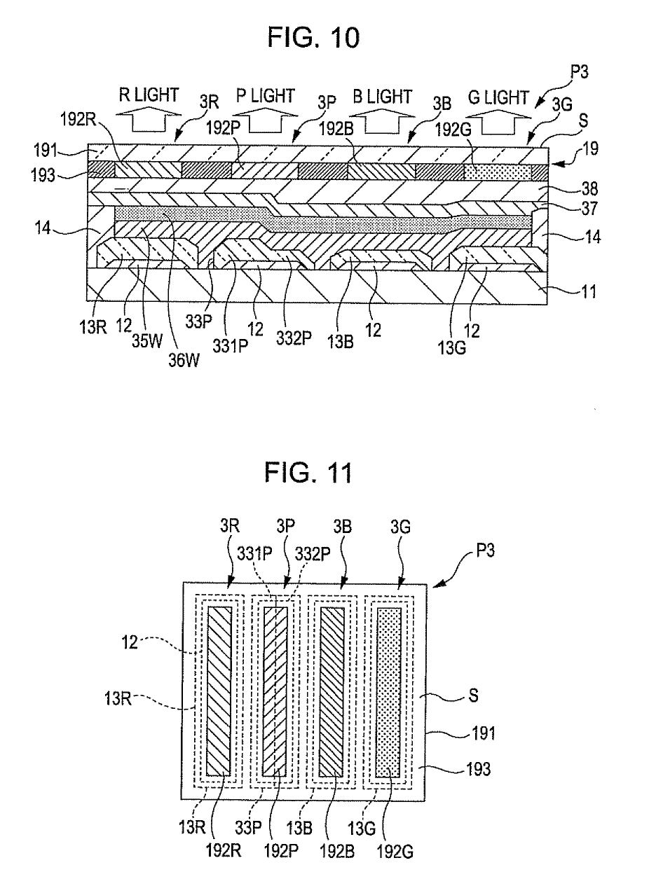

FIG. 10 is a sectional view that schematically illustrates an example of the configuration of a pixel P3 of a light-emitting apparatus according to a third exemplary embodiment of the invention. FIG. 11 is a plan view that schematically illustrates an example of the configuration of the pixel P3. The pixel P3 of the light-emitting apparatus according to the third exemplary embodiment of the invention corresponds to the pixel P of the light-emitting apparatus 10 according to the first exemplary embodiment of the invention. The configuration of the light-emitting apparatus according to the present embodiment of the invention, which is illustrated in these drawings, differs from that of the light-emitting apparatus 10 according to the first exemplary embodiment of the invention in that the light-emitting apparatus according to the present embodiment of the invention is provided with, in each pixel thereof, a red sub pixel 3R, a pink sub pixel 3P, a blue sub pixel 3B, and a green sub pixel 3G in place of the red sub pixel 1R, the pink sub pixel 1P, the blue sub pixel 1B, and the green sub pixel 1G.

The red sub pixel 3R, the pink sub pixel 3P, and the blue sub pixel 3B differ substantially from the red sub pixel 1R, the pink sub pixel 1P, and the blue sub pixel 1B in that the red sub pixel 3R, the pink sub pixel 3P, and the blue sub pixel 3B are provided with a red transparent electrode (i.e., red light-transmissive layer) 33R, a pink transparent electrode (i.e., pink light-transmissive layer) 33P, and a blue transparent electrode (i.e., blue light-transmissive layer) 33B in place of the red transparent electrode 13R, the pink transparent electrode 13P, and the blue transparent electrode 13B, respectively. Unlike the red transparent electrode 13R, the pink transparent electrode 13P, and the blue transparent electrode 13B, which have an equal thickness, the thicknesses of the red transparent electrode 33R, the pink transparent electrode 33P, and the blue transparent electrode 33B are different from one another. Specifically, the thickness of the red transparent electrode 33R is, for example, 130 nm, whereas the thickness of the blue transparent electrode 33B is, for example, 85 nm. The pink transparent electrode 33P has two portions 331P and 332P that have thicknesses different from each other. Specifically, the thickness of the portion 331P of the pink transparent electrode 33P is set at a value that ensures that, among all components of light emitted by the light-emitting layer, light that has a spectrum falling within the red wavelength range, specifically, within a range from 590 nm inclusive to 640 nm inclusive (preferably, 620 nm or in the neighborhood thereof) is intensified due to optical interference whereas the thickness of the portion 332P of the pink transparent electrode 33P is set at a value that ensures that, among all components of light emitted by the light-emitting layer, light that has a spectrum falling within the blue wavelength range, specifically, within a range from 450 nm inclusive to 500 nm inclusive (preferably, 480 nm or in the neighborhood thereof) is intensified due to optical interference.

The thickness of the red transparent electrode 33R is set at a value that ensures that, among all components of light emitted by the light-emitting layer, light that has a spectrum falling within the red wavelength range, specifically, within a range from 590 nm inclusive to 640 nm inclusive (preferably, 620 nm or in the neighborhood thereof) is intensified due to optical interference. The thickness of the blue transparent electrode 333 is set at a value that ensures that, among all components of light emitted by the light-emitting layer, light that has a spectrum falling within the blue wavelength range, specifically, within a range from 450 nm inclusive to 500 nm inclusive (preferably, 480 nm or in the neighborhood thereof) is intensified due to optical interference. Since the shape of a set of the red transparent electrode 33R, the pink transparent electrode 33P, and the blue transparent electrode 33B differs from that of a set of the red transparent electrode 13R, the pink transparent electrode 13P, and the blue transparent electrode 13B, in the configuration of the light-emitting apparatus according to the present embodiment of the invention, the shapes of a white hole injection layer, a white light-emitting layer, a white electron injection layer (which is not shown in the drawing), a common electrode, and a sealing layer differ from the shapes of counterparts of the light-emitting apparatus 10 according to the first exemplary embodiment of the invention, respectively. This is the reason why the green sub pixel 3G differs substantially from the green sub pixel 1G.

In the red sub pixel 3R, the pink sub pixel 3P, and the blue sub pixel 3B of the light-emitting apparatus according to the present embodiment of the invention, light that has a certain wavelength is intensified due to optical interference among all components of light emitted by the light-emitting layer thereof. Therefore, a light-emitting apparatus according to the present embodiment of the invention makes it possible to increase the brightness level of each of the red sub pixel 3R, the pink sub pixel 3P, and the blue sub pixel 3B. In the pink sub pixel 3P thereof, it is unlikely that the hue of P light gets undesirably changed as a result of the intensification of any specific light that has a certain wavelength due to optical interference because light component of a red peak wavelength and light component of a blue peak wavelength (red light and blue light) are intensified among three peaks of the emission spectrum of the light-emitting layer thereof due to optical interference. Therefore, with the configuration of the light-emitting apparatus according to the present embodiment of the invention, it is possible to avoid the purity of the color represented by the pink sub pixel 3P from being degraded.

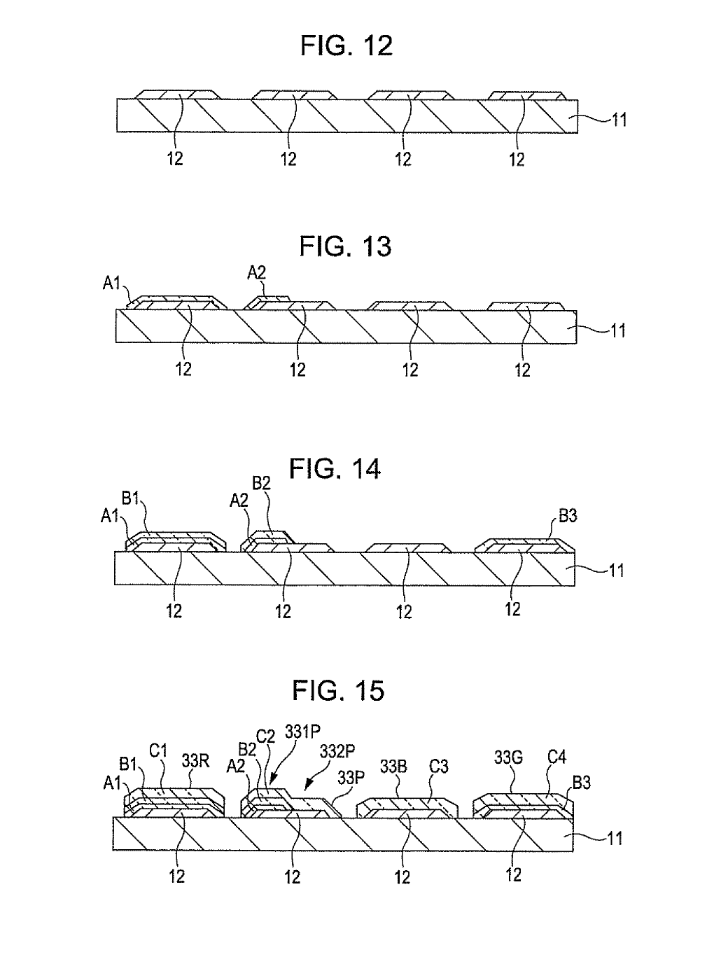

Next, a method for producing the light-emitting apparatus according to the present embodiment of the invention is explained below. As illustrated in FIG. 12, as a first step, the light-reflective layer 12 is formed for each of the sub pixels 3 over the element substrate 11. Next, a passivation layer, which is not shown in the drawing, is formed to overlie both of the element substrate 11 and the light-reflective layer 12. Then, as illustrated in FIGS. 12, 13, 14, and 15, the transparent electrode 33 is formed over the passivation layer (not shown) for each of the plurality of sub pixels 3 in such a manner that it covers the light-reflective layer 12.

The formation of the transparent electrodes 33 is performed as follows. As a first step thereof, as illustrated in FIG. 13, a sub-light-transmissive layer A1 and a sub-light-transmissive layer A2 are formed on the passivation layer (not shown) in the same single film formation process. Each of the sub-light-transmissive layer A1 and the sub-light-transmissive layer A2 is made of a transparent material that constitutes the transparent electrode 33. The formation of the sub-light-transmissive layers A1 and A2 is performed as follows. A sub-light-transmissive layer having a film thickness of A is formed so as to cover all of the light-reflective layers 12 (hereafter referred to as a “formation step”). Then, the unnecessary portion of the formed sub-light-transmissive layer is etched away (hereafter referred to as a “removal step”). The remaining portion thereof after the etching process constitutes the sub-light-transmissive layers A1 and A2. The sub-light-transmissive layer A1 covers the entire surface area of the light-reflective layer 12 of the red sub pixel 3R, whereas the sub-light-transmissive layer A2 covers a partial surface area of the light-reflective layer 12 of the pink sub pixel 3P (i.e., a surface parallel to the element substrate 11 in the pink sub pixel 3P).

As illustrated in FIG. 14, sub-light-transmissive layers B1, B2, and B3 are formed thereon in the same single film formation process. Each of the sub-light-transmissive layers E1, B2, and B3 is made of the formation material of the transparent electrode 33. The formation of the sub-light-transmissive layers B1, B2, and B3 is performed as follows. A sub-light-transmissive layer having a film thickness of B is formed so as to cover all of the light-reflective layers 12. Then, the unnecessary portion of the formed sub-light-transmissive layer is etched away. The remaining portion thereof constitutes the sub-light-transmissive layers B1, B2, and 33. The sub-light-transmissive layer B1 is formed over the entire surface area of the light-reflective layer 12 of the red sub pixel 3R, whereas the sub-light-transmissive layer B2 is formed over a partial surface area of the light-reflective layer 12 of the pink sub pixel 3P (i.e., a surface parallel to the element substrate 11 in the pink sub pixel 3P). The sub-light-transmissive layer B3 covers the entire surface area of the light-reflective layer 12 of the green sub pixel 3G.

As illustrated in FIG. 15, sub-light-transmissive layers C1, C2, C3, and C4 are formed thereon in the same single film formation process. Each of the sub-light-transmissive layers C1, C2, C3, and C4 is made of the formation material of the transparent electrode 33. The formation of the sub-light-transmissive layers C1, C2, C3, and C4 is performed as follows. A sub-light-transmissive layer having a film thickness of C is formed so as to cover all of the light-reflective layers 12. Then, the unnecessary portion of the formed sub-light-transmissive layer is etched away. The remaining portion thereof constitutes the sub-light-transmissive layers C1, C2, C3, and C4. The sub-light-transmissive layer C1 is formed over the entire surface area of the light-reflective layer 12 of the red sub pixel 3R. The sub-light-transmissive layer C2 is also formed over the entire surface area of the light-reflective layer 12 of the pink sub pixel 3P (i.e., a surface parallel to the element substrate 11 in the pink sub pixel 3P) so as to constitute a dual-level layer of the pink sub pixel 3P. The sub-light-transmissive layer C3 covers the entire surface area of the light-reflective layer 12 of the blue sub pixel 3B. In addition, the sub-light-transmissive layer C4 is formed over the entire surface area of the light-reflective layer 12 of the green sub pixel 3G.

Through the series of formation steps described above, the transparent electrode 33 is formed for each of the sub pixels 3. As understood from the above explanation, the thickness of the red transparent electrode 33R equals A+B+C. The thickness of the green transparent electrode 33G equals B+C. The thickness of the blue transparent electrode 33B equals C. The thickness of the portion 331P of the pink transparent electrode 33P equals A+B+C, whereas the thickness of the portion 332P thereof equals C. Let the ideal thickness of the red transparent electrode 33R be X, the ideal thickness of the green transparent electrode 33G be Y, and the ideal thickness of the blue transparent electrode 33B be Z. In the formation process of the sub-light-transmissive layers, the following simultaneous equations hold true on the basis of these mathematical relations: A=X−Y - - - (1), B=Y−Z - - - (2), and C=Z−0=Z - - - (3). In other words, the thickness of the nth-film sub-light-transmissive layer equals to a difference between the nth thickness of the transparent electrode 33 and the (n+1)th thickness thereof. Herein, the thickness of any sub-light-transmissive layer that does not actually exist is taken as zero.

In the method for producing the light-emitting apparatus according to the present embodiment of the invention, the above-mentioned formation step and the above-mentioned removal step are performed alternately in a repeated manner. In the formation step, the sub-light-transmissive layer that is made of a material having optical transparency is formed so as to cover a surface parallel to the element substrate 11 in the pink sub pixel 3P. In the removal step, a part of the sub-light-transmissive layer formed in the formation step is removed. Therefore, the light-emitting apparatus according to the present embodiment of the invention and the method for production thereof make it possible to form a fine structure that is difficult to be formed in a deposition mask method. Specifically, it is possible to form a plurality of portions 331P and 332P that have thicknesses different from each other in the pink transparent electrode 33P of the pink sub pixel 3P.

### Fourth Embodiment

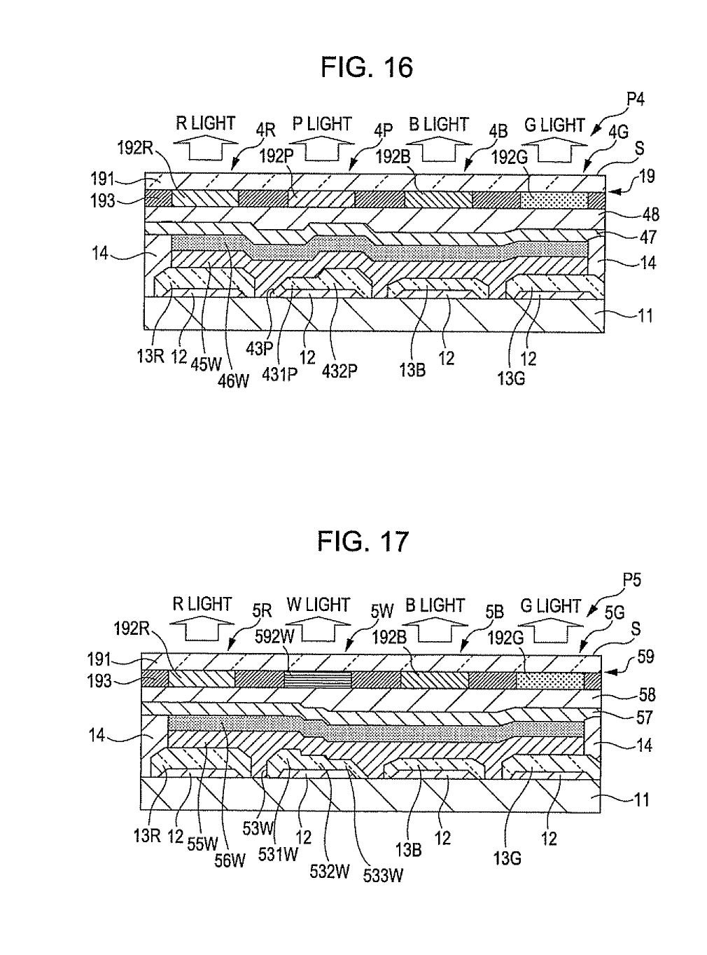

FIG. 16 is a sectional view that schematically illustrates an example of the configuration of a pixel P4 of a light-emitting apparatus according to a fourth exemplary embodiment of the invention. The pixel P4 corresponds to the pixel P3 illustrated in FIG. 10. The pixel P4 according to the present embodiment of the invention differs from the pixel P3 according to the third exemplary embodiment of the invention in that the pixel P4 is provided with a red sub pixel 4R, a pink sub pixel 4P, a blue sub pixel 4B, and a green sub pixel 4G in place of the red sub pixel 3R, the pink sub pixel 3P, the blue sub pixel 3B, and the green sub pixel 3G.

The pink sub pixel 4P differs substantially from the pink sub pixel 3P in that the pink sub pixel 4P is provided with a pink transparent electrode (i.e., light-transmissive layer) 43P in place of the pink transparent electrode 33P. The pink transparent electrode 43P has a portion 4312 and a portion 432P. The thickness of the portion 431P is the same as that of the portion 3322. The thickness of the portion 432P is the same as that of the portion 3312. In the configuration of the pink transparent electrode 33P, the thickest portion 331P is formed at a position closer to the red sub pixel 3R. In contrast, in the configuration of the pink transparent electrode 43P, the thinnest portion 431P is formed at a position closer to the red sub pixel 4R.

Since the shape of the pink transparent electrode 43P differs from that of the pink transparent electrode 33P, in the configuration of the light-emitting apparatus according to the present embodiment of the invention, the shapes of a white hole injection layer, a white light-emitting layer, a white electron injection layer (which is not shown in the drawing), a common electrode, and a sealing layer differ from the shapes of counterparts of the light-emitting apparatus according to the third exemplary embodiment of the invention, respectively. This is the reason why the red sub pixel 4R, the blue sub pixel 4B, and the green sub pixel 4G differ substantially from the red sub pixel 3R, the blue sub pixel 3B, and the green sub pixel 3G, respectively.

The light-emitting apparatus according to the present embodiment of the invention produces the same advantageous effects as those of the third exemplary embodiment of the invention. As understood from the above explanation, the cross-sectional shape of the pink transparent electrode is not limited to the specific example illustrated in the drawing. As a non-limiting modification example thereof, the above-mentioned two portions may be arranged in a perpendicular direction with respect to the sheet face of FIG. 16.

### Fifth Embodiment

FIG. 17 is a sectional view that schematically illustrates an example of the configuration of a pixel P5 of a light-emitting apparatus according to a fifth exemplary embodiment of the invention. The pixel P5 corresponds to the pixel P3 illustrated in FIG. 10. The pixel P5 according to the present embodiment of the invention differs from the pixel P3 according to the third exemplary embodiment of the invention in that the pixel P5 is provided with a red sub pixel 5R, a white sub pixel 5W, a blue sub pixel 5B, and a green sub pixel 5G in place of the red sub pixel 3R, the pink sub pixel 3P, the blue sub pixel 3B, and the green sub pixel 3G. The white sub pixel 5W is a sub pixel that represents white. The white sub pixel 5W emits W light. In the configuration of a light-emitting apparatus according to the present embodiment of the invention, white is represented by the white sub pixel 5W only.

The white sub pixel 5W differs substantially from the pink sub pixel 3P in the following two points. Firstly, the white sub pixel 5W has a color filter (i.e., light-transmissive layer) 592W, which transmits white light, in place of the color filter 192P. Secondly, the white sub pixel 5W has a white transparent electrode (i.e., light-transmissive layer) 53W in place of the pink transparent electrode 33P. The color filter 592W is made of a light-transmissive material that transmits visible light of all wavelengths. The white transparent electrode 53W has three portions 531W, 532W, and 533W that have thicknesses different from one another. The thickness of the portion 531W is set at a value that ensures that, among all components of light emitted by the light-emitting layer, light that has a spectrum falling within the red wavelength range, specifically, within a range from 590 nm inclusive to 640 nm inclusive (preferably, 620 nm or in the neighborhood thereof) is intensified due to optical interference. The thickness of the portion 532W is set at a value that ensures that, among all components of light emitted by the light-emitting layer, light that has a spectrum falling within the green wavelength range, specifically, within a range from 500 nm inclusive to 570 nm inclusive (preferably, 530 nm or in the neighborhood thereof) is intensified due to optical interference. The thickness of the portion 533W is set at a value that ensures that, among all components of light emitted by the light-emitting layer, light that has a spectrum falling within the blue wavelength range, specifically, within a range from 450 nm inclusive to 500 nm inclusive (preferably, 480 nm or in the neighborhood thereof) is intensified due to optical interference.

In the white sub pixel 5W of the light-emitting apparatus according to the present embodiment of the invention, light that has a certain wavelength is intensified due to optical interference among all components of light emitted by the light-emitting layer thereof. Therefore, a light-emitting apparatus according to the present embodiment of the invention makes it possible to increase the brightness level of the white sub pixel 5W. In the white sub pixel 5W thereof, it is unlikely that the hue of W light gets undesirably changed as a result of the intensification of any specific light that has a certain wavelength due to optical interference because light component of a red peak wavelength, light component of a green peak wavelength, and light component of a blue peak wavelength (red light, green light, and blue light), that is, all of three peaks of the emission spectrum of the light-emitting layer thereof, are intensified due to optical interference. Therefore, with the configuration of the light-emitting apparatus according to the present embodiment of the invention, it is possible to avoid the purity of the color represented by the white sub pixel 5W from being degraded. As a non-limiting modification example of the light-emitting apparatus according to the present embodiment of the invention, the above-mentioned three portions may be arranged in a perpendicular direction with respect to the sheet face of FIG. 17. As another non-limiting modification example thereof, either the portion 532W or the portion 533W in place of the portion 531W may be formed at a position closest to the red sub pixel 5R among these three portions.

### Sixth Embodiment

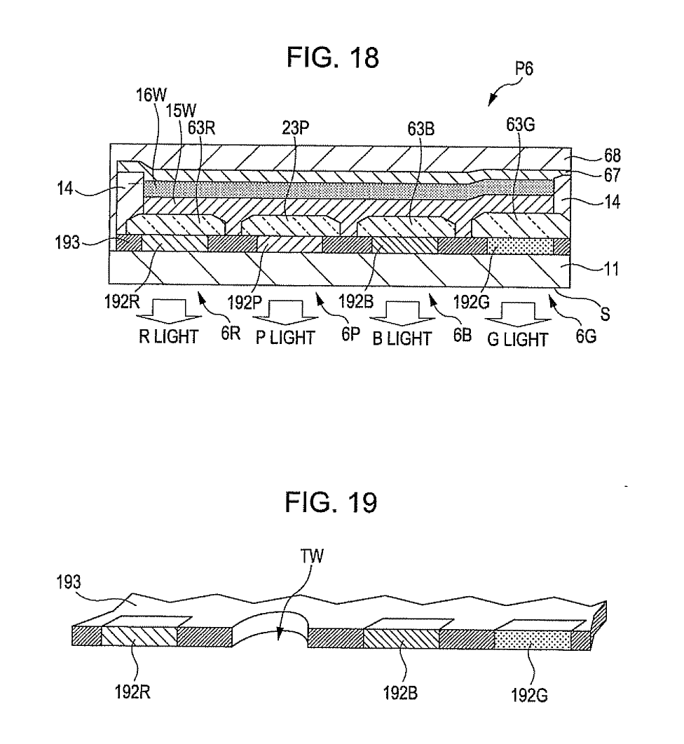

FIG. 18 is a sectional view that schematically illustrates an example of the configuration of a pixel P6 of a light-emitting apparatus according to a sixth exemplary embodiment of the invention. A light-emitting apparatus according to the present embodiment of the invention is configured as a bottom-emission type light-emitting apparatus. Therefore, the material of the element substrate 11 of the light-emitting apparatus according to the present embodiment of the invention is limited to one that has optical transparency (e.g., glass). Since a light-emitting apparatus according to the present embodiment of the invention is configured as a bottom-emission type apparatus, it has the color filter 192 and the black matrix 193 between the element substrate 11 and the transparent electrodes 63R, 23P, 63B, and 63G in place of the reflective layer 12. In addition, a light-emitting apparatus according to the present embodiment of the invention does not have the color filter substrate 19.

That is, in each of the pixels P6, the red color filter 192R, the pink color filter 192P, the blue color filter 192B, and the green color filter 192G are interposed between a light-emitting layer and the element substrate 11 in a red sub pixel 6R, a pink sub pixel 6P, a blue sub pixel 6B, and a green sub pixel 6G, respectively. Active elements such as thin film transistors (TFTs) are formed over the element substrate 11 at a region that overlaps the black matrix 193 in a plan view.

The pixel P6 corresponds to the pixel P2 illustrated in FIG. 9. A red sub pixel 6R, a pink sub pixel 6P, a blue sub pixel 6B, and a green sub pixel 6G correspond to the red sub pixel 1R, the pink sub pixel 2P, the blue sub pixel 1B, and the green sub pixel 1G illustrated in FIG. 9, respectively. A common electrode 67 corresponds to the common electrode 17 illustrated in FIG. 9. A sealing layer 68 corresponds to the sealing layer 18 illustrated therein. Each of the common electrode 67 and the sealing layer 68 is made of a transparent material, as is the case with each of the common electrode 17 and the sealing layer 18. Notwithstanding the foregoing, a light-emitting apparatus according to the present embodiment of the invention may be modified in such a manner that each of the common electrode 67 and the sealing layer 68 is made of a light-shielding material.

As explained above, the invention is also applicable to a bottom-emission type light-emitting apparatus. A light-emitting apparatus according to the present embodiment of the invention may be modified so as to produce the same advantageous effects as those of the first, second, third, fourth, and fifth embodiments described above. For example, a common electrode 77 may be made of a light-reflective material so as to intensify outgoing light due to optical interference. As another or additional modification example, a passivation layer, which is made of, for example, silicon nitride, may be formed over the color filter 192 and the black matrix 193. In such an example, a thin film layer having a thickness of approximately 5-15 nm, which is made of a material having a high reflection factor such as silver or aluminum, is formed over the passivation layer as a transflective layer (i.e., a half mirror). Transparent electrodes are formed on the transflective layer. In such a modified configuration, the optical distance between the transflective layer and the reflective layer (i.e., common electrode) can be adjusted by arbitrary setting either the thickness of the transparent electrode only or the thicknesses of both the transparent electrode and the organic functional layer. As another modification example, the transparent electrode may be made of a gold thin film or a silver thin film so that it functions as the above-mentioned transflective layer. In such a modified configuration, the optical distance between the transflective layer and the reflective layer can be adjusted by arbitrary setting either the thickness of the transparent electrode only or the thicknesses of both the transparent electrode and the organic functional layer. That is, each of the red sub-pixel, the blue sub pixel, and the green sub pixel may be configured to have the transflective layer between the light-emitting layer and the color filter thereof. In such a configuration, ITO may be used as an auxiliary positive electrode. As still another modification example, it may be configured that the transflective layer is provided in each pink sub pixel and that the pink transparent electrode has a plurality of portions that have thicknesses different from each other.

### Other Variation Examples

A light-emitting apparatus according to each of the exemplary embodiments of the invention described above may be modified as follows. The non-limiting variation examples described below are also encompassed within the technical scope of the invention. In a modified configuration example where the transparent electrodes and the passivation layer, the latter of which is made of, for example, silicon nitride or silicon oxide, are provided between the reflective layer and the transflective layer, the optical distance between the reflective layer and the transflective layer may be adjusted by arbitrary setting the thickness of the transparent electrodes and the thickness of the passivation layer.

As another variation example, a “through window” TW may be provided in place of the color filter 592W that transmits white light. A non-limiting example of the through window TW is illustrated in FIG. 19. The through window TW is configured as a layer of transparent gas (e.g., air space). The through window TW functions as a color filter that transmits white light. A light-emitting apparatus having such a configuration has, in each pixel thereof, a white sub pixel in place of a pink sub pixel. A light-emitting apparatus having such a configuration represent white by means of the white sub pixel only. Throughout the description made herein as well as in the recitations of appended claims, a white sub pixel constitutes a non-limiting example of a “remaining sub pixel” among a set of four sub pixels, which is not a red sub pixel, a green sub pixel, or a blue sub pixel. The same applies for a pink sub pixel.

In addition, as a non-limiting aspect thereof, the invention can be defined as a method for producing a light-emitting apparatus that has a plurality of pixels each of which has a set of four sub pixels and, as a whole, which make up a display screen, the light-emitting apparatus, in each one of the pixels thereof, including: a red sub pixel that is one of the above-mentioned four sub pixels, the red sub pixel having a light-emitting layer and a red color filter, the light-emitting layer of the red sub pixel being made of a white light-emitting material that emits three-peak white light, the emission spectrum of the three-peak white light that is emitted by the white light-emitting material having a red peak, a green peak, and a blue peak, the red peak falling within the wavelength range of red light, the green peak falling within the wavelength range of green light, and the blue peak falling within the wavelength range of blue light, low intensity regions existing between the red peak and the green peak as well as between the green peak and the blue peak, the light-emitting layer of the red sub pixel extending along the display screen, the red color filter overlapping the light-emitting layer of the red sub pixel in a plan view, the red color filter transmitting red light; a green sub pixel that is one of the above-mentioned four sub pixels, the green sub pixel having a light-emitting layer and a green color filter, the light-emitting layer of the green sub pixel being made of the white light-emitting material, the light-emitting layer of the green sub pixel extending along the display screen, the green color filter overlapping the light-emitting layer of the green sub pixel in a plan view, the green color filter transmitting green light; a blue sub pixel that is one of the above-mentioned four sub pixels, the blue sub pixel having a light-emitting layer and a blue color filter, the light-emitting layer of the blue sub pixel being made of the white light-emitting material, the light-emitting layer of the blue sub pixel extending along the display screen, the blue color filter overlapping the light-emitting layer of the blue sub pixel in a plan view, the blue color filter transmitting blue light; and a remaining sub pixel that is one of the above-mentioned four sub pixels, the remaining sub pixel having a light-emitting layer, the light-emitting layer of the remaining sub pixel being made of the white light-emitting material, the light-emitting layer of the remaining sub pixel extending along the display screen, the above-described light-emitting apparatus further including a flat element substrate, wherein, in each of the pixels, the light-emitting layer of each of the above-mentioned four sub pixels is formed over the element substrate in such a manner that the light-emitting layer of each of the red sub pixel, the green sub pixel, and the blue sub pixel is interposed between the corresponding color filter and the element substrate; each of the above-mentioned four sub pixels has a light-transmissive layer, which has optical transparency, between the corresponding light-emitting layer and the element substrate; the remaining sub pixel of each of the pixels has a light-reflective layer, which has optical reflectivity, between the corresponding light-transmissive layer and the element substrate; the light-transmissive layer of the remaining sub pixel of each of the pixels has a plurality of portions that have thicknesses different from each other or one another, the above-mentioned method for producing a light-emitting apparatus comprising: a formation step of forming a sub-light-transmissive layer that is made of a material having optical transparency so as to cover a surface parallel to the element substrate in the remaining sub pixel; and a removal step of removing a part of the sub-light-transmissive layer formed in the formation step, wherein the formation step and the removal step are performed alternately in a repeated manner.

With the configuration of a light-emitting apparatus that is manufactured by the above-mentioned production method, it is possible to display an image with high quality with low power consumption. In addition, since an etching treatment can be used in the method for production of the light-emitting apparatus described above, it is possible to form a fine structure that is difficult to be formed in a deposition mask method. Specifically, it is possible to form a plurality of portions that have thicknesses different from each other or one another in the light-transmissive layer of the remaining sub pixel in each of the pixels thereof. That is, with the configuration of the light-emitting apparatus that is manufactured by the production method according to the present embodiment of the invention, it is possible to avoid the purity of the color represented by the remaining sub pixel from being degraded. In addition thereto, it is further possible to increase the brightness level of the remaining sub pixel in each of the pixels thereof. As explained above, with the production method according to the present embodiment of the invention, it is possible to manufacture a light-emitting apparatus that is capable of displaying an image with high quality with low power consumption, which can be manufactured with a sufficiently simple production process.

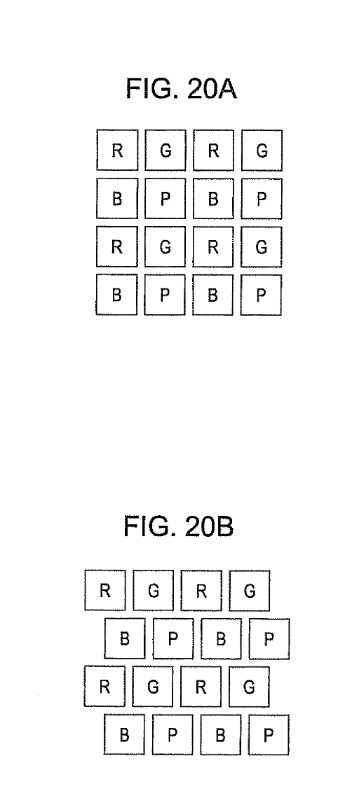

As still another variation example thereof, all sub pixels may be arrayed in a matrix pattern as illustrated in FIG. 20A. As a further modification of FIG. 20A, all sub pixels may be arrayed in a “staggered” matrix pattern as illustrated in FIG. 20B. In the latter (i.e., staggered) array pattern, the positions of sub pixels arranged on each of odd rows and the positions of sub pixels arranged on each of even rows are shifted with respect to each other when viewed along a column direction. In each of FIGS. 20A and 20B, reference alphabets “R”, “G”, “B”, and “P” denote the red sub pixel, the green sub pixel, the blue sub pixel, and the pink sub pixel, respectively.

As still another variation example, one electrode of a pair of the organic EL element that is closer to the element substrate may be configured as a negative electrode, whereas the other electrode thereof may be configured as a positive electrode. As still another variation example, an EL element other than the organic EL element (i.e., an inorganic EL element) may be adopted as the light-emitting element of the light-emitting apparatus according to the invention. In the foregoing description of the light-emitting apparatus that has the white sub pixel in each pixel thereof, it is explained that light that has a certain wavelength is intensified due to optical interference among all components of light emitted by the light-emitting layer thereof. In connection therewith, the above-described configuration may be modified so that light components of any two peaks are intensified among three peaks of the emission spectrum of the light-emitting layer thereof due to optical interference. In other words, the number of a plurality of portions in the light-emitting layer of the white sub pixel that has thicknesses different from each other (one another) may be two in place of three. In the foregoing description of the light-emitting apparatus that has the pink sub pixel in each pixel thereof in which light that has a certain wavelength is intensified due to optical interference among all components of light emitted by the light-emitting layer thereof, the above-described configuration may be modified so that light components of all three peaks of the emission spectrum of the light-emitting layer thereof are intensified due to optical interference. In other words, the number of a plurality of portions in the light-emitting layer of the pink sub pixel that has thicknesses different from one another (each other) may be three in place of two.

### Application

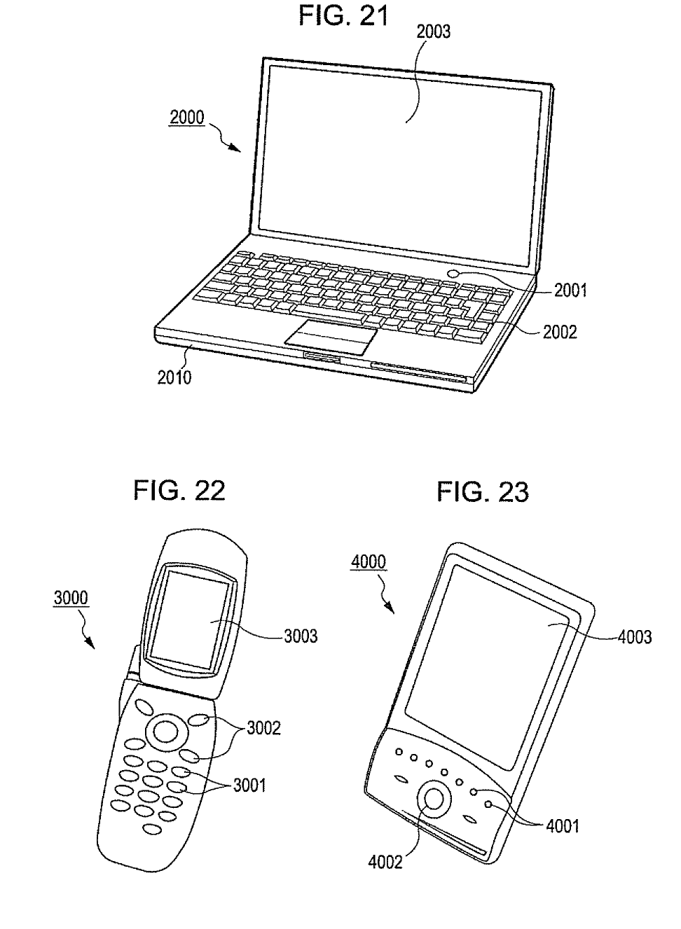

The light-emitting apparatus according to exemplary embodiments of the invention described above is applicable to a variety of electronic apparatuses. Each of FIGS. 21, 22, and 23 illustrates an exemplary configuration of an electronic apparatus that is provided with the light-emitting apparatus 10 as the display device thereof.

FIG. 21 is a diagram that schematically illustrates an example of the configuration of a mobile personal computer that adopts the light-emitting apparatus 10 as its display device. A personal computer 2000 has a display device 2003 (i.e., light-emitting apparatus 10) and a main assembly 2010. The main assembly 2010 is provided with a power switch 2001 and a keyboard 2002.

FIG. 22 is a diagram that schematically illustrates an example of the configuration of a mobile phone that adopts the light-emitting apparatus 10 as its display device. A mobile phone 3000 is provided with a plurality of manual operation buttons 3000, scroll buttons 3002, and the light-emitting apparatus 10 that functions as a display device 3003. As a user manipulates the scroll buttons 3002, content displayed on the screen of the light-emitting apparatus 10 is scrolled.

FIG. 23 is a diagram that schematically illustrates an example of the configuration of a personal digital assistant (PDA) that adopts the light-emitting apparatus 10 as its display device. A personal digital assistant 4000 is provided with a plurality of manual operation buttons 4001, a power switch 4002, and the light-emitting apparatus 10 that functions as a display device 4003. As a user manipulates the power switch 4002, various kinds of information including but not limited to an address list or a schedule table is displayed on the light-emitting apparatus 10.

Among a variety of electronic apparatuses to which the light-emitting apparatus according to the exemplary embodiments of the invention described above is applicable are, other than the specific examples illustrated in FIGS. 21-23, a digital still camera, a television, a video camera, a car navigation device, a pager, an electronic personal organizer, an electronic paper, a word processor, a workstation, a videophone, a POS terminal, a printer, a copier, a video player, a touch-panel device, and so forth.

What is claimed is:

1. A light-emitting apparatus that has a plurality of pixels each of which has a set of four sub pixels and, as a whole, which make up a display screen, the light-emitting apparatus, in each one of the pixels thereof, comprising:
a red sub pixel that is one of the above-mentioned four sub pixels, the red sub pixel having a light-emitting layer and a red color filter,
the light-emitting layer of the red sub pixel being made of a white light-emitting material that emits three-peak white light, the emission spectrum of the three-peak white light that is emitted by the white light-emitting material having a red peak, a green peak, and a blue peak, the red peak falling within the wavelength range of red light, the green peak falling within the wavelength range of green light, and the blue peak falling within the wavelength range of blue light, low intensity regions existing between the red peak and the green peak as well as between the green peak and the blue peak, the light-emitting layer of the red sub pixel extending along the display screen,
the red color filter overlapping the light-emitting layer of the red sub pixel in a plan view, the red color filter transmitting red light;
a green sub pixel that is one of the above-mentioned four sub pixels, the green sub pixel having a light-emitting layer and a green color filter,
the light-emitting layer of the green sub pixel being made of the white light-emitting material, the light-emitting layer of the green sub pixel extending along the display screen,
the green color filter overlapping the light-emitting layer of the green sub pixel in a plan view, the green color filter transmitting green light;
a blue sub pixel that is one of the above-mentioned four sub pixels, the blue sub pixel having a light-emitting layer and a blue color filter,
the light-emitting layer of the blue sub pixel being made of the white light-emitting material, the light-emitting layer of the blue sub pixel extending along the display screen,
the blue color filter overlapping the light-emitting layer of the blue sub pixel in a plan view, the blue color filter transmitting blue light; and
a remaining sub pixel that is one of the above-mentioned four sub pixels, the remaining sub pixel having a light-emitting layer,
the light-emitting layer of the remaining sub pixel being made of the white light-emitting material, the light-emitting layer of the remaining sub pixel extending along the display screen.

2. The light-emitting apparatus according to claim 1, wherein, in each one of the pixels thereof, the remaining sub pixel is a pink sub pixel that has a pink color filter overlapping the light-emitting layer in a plan view, the pink color filter transmitting pink light.

3. The light-emitting apparatus according to claim 2, further comprising:
a flat element substrate,
wherein, in each of the pixels, the light-emitting layer of each of the above-mentioned four sub pixels is formed over the element substrate in such a manner that the light-emitting layer of each of the above-mentioned four sub pixels is interposed between the corresponding color filter and the element substrate;
each of the above-mentioned four sub pixels has a light-transmissive layer, which has optical transparency, between the corresponding light-emitting layer and the element substrate;
each of the above-mentioned four sub pixels has a light-reflective layer, which has optical reflectivity, between the corresponding light-transmissive layer and the element substrate; and
the thickness of the light-transmissive layer of each of the red sub pixel, the blue sub pixel, and the pink sub pixel is set at a value equal to one another so that light having a wavelength of the red peak and light having a wavelength of the blue peak are intensified concurrently with each other due to optical interference, whereas the thickness of the light-transmissive layer of the green sub pixel is set at a value so that light having a wavelength of the green peak is intensified due to optical interference.

4. The light-emitting apparatus according to claim 1, wherein, in each of the pixels, the remaining sub pixel is a white sub pixel that represents white.

5. The light-emitting apparatus according to claim 4, further comprising:
a flat element substrate,
wherein, in each of the pixels, the light-emitting layer of each of the above-mentioned four sub pixels is formed over the element substrate in such a manner that the light-emitting layer of each of the above-mentioned four sub pixels is interposed between the corresponding color filter and the element substrate;
each of the above-mentioned four sub pixels has a light-transmissive layer, which has optical transparency, between the corresponding light-emitting layer and the element substrate;
each of the above-mentioned four sub pixels has a light-reflective layer, which has optical reflectivity, between the corresponding light-transmissive layer and the element substrate;
the thickness of the light-transmissive layer of the red sub pixel is set at a value so that light having a wavelength of the red peak is intensified due to optical interference;
the thickness of the light-transmissive layer of the green sub pixel is set at a value so that light having a wavelength of the green peak is intensified due to optical interference;
the thickness of the light-transmissive layer of the blue sub pixel is set at a value so that light having a wavelength of the blue peak is intensified due to optical interference; and
the light-transmissive layer of the remaining sub pixel has three portions that have thicknesses different from one another, the thickness of a first portion of the light-transmissive layer of the remaining sub pixel being set at a value so that light having a wavelength of the red peak is intensified due to optical interference, the thickness of a second portion of the light-transmissive layer of the remaining sub pixel being set at a value so that light having a wavelength of the green peak is intensified due to optical interference, and the thickness of a third portion of the light-transmissive layer of the remaining sub pixel being set at a value so that light having a wavelength of the blue peak is intensified due to optical interference.

6. The light-emitting apparatus according to claim 1, further comprising:
a flat element substrate; and
a light absorption layer that is formed under the element substrate,
wherein, in each of the pixels, the light-emitting layer of each of the above-mentioned four sub pixels is formed over the element substrate in such a manner that the light-emitting layer of each of the red sub pixel, the green sub pixel, and the blue sub pixel is interposed between the corresponding color filter and the element substrate.

7. The light-emitting apparatus according to claim 1, further comprising: a flat element substrate,
wherein, in each of the pixels, the light-emitting layer of each of the above-mentioned four sub pixels is formed over the element substrate in such a manner that the color filter of each of the red sub pixel, the green sub pixel, and the blue sub pixel is interposed between the corresponding light-emitting layer and the element substrate; and
each of the red sub pixel, the green sub pixel, and the blue sub pixel has a transflective layer having optical transparency and optical reflectivity between the corresponding light-emitting layer and the corresponding color filter.

8. The light-emitting apparatus according to claim 1, wherein, in each of the pixels, the light-emitting layer of the red sub pixel, the light-emitting layer of the green sub pixel, the light-emitting layer of the blue sub pixel, and the light-emitting layer of the remaining sub pixel constitute the same single light-emitting layer.

9. An electronic apparatus that is provided with the light-emitting apparatus according to claim 1.
